(19) United States
(12) Patent Application Publication
(10) Pub. No.: US 2022/0141730 A1
(43) Pub. Date: May 5, 2022

(54) Mobility between Cells in a Wireless Network

(71) Applicant: Telefonaktiebolaget LM Ericsson (publ), Stockholm (SE)

(72) Inventors: Helka-Liina Määttänen, Helsinki (FI); Jens Bergqvist, Linköping (SE); Björn Hofström, Linköping (SE)

(21) Appl. No.: 17/431,203

(22) PCT Filed: Feb. 5, 2020
(86) PCT No.: PCT/SE2020/050111

§ 371 Date: Aug. 16, 2021

Related U.S. Application Data
(60) Provisional application No. 62/807,985, filed on Feb. 20, 2019.

(51) Int. Cl. H04W 36/00; H04W 36/32

(52) U.S. Cl. CPC H04W 36/0072; H04W 36/32; H04W 36/0058

(57) ABSTRACT

One aspect of the disclosure provides a method performed by a wireless device for performing handover from a source network node to a target network node. The method comprises: obtaining (1402) an indication of a round-trip time for transmissions to the target network node; initiating (1406) access to the target network node; and, subsequent to initiating access to the target network node, transmitting (1408) data to or receiving (1408) data from the source network node for a time window following initiation of access to the target network node. The time window has a duration of at least the round-trip time for transmissions to the target network node.

### TECHNICAL FIELD

Embodiments of the disclosure relate wireless communications, and particularly to methods and apparatus relating to mobility between cells in a wireless network.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Non-terrestrial networks (NTNs) refer to networks, or segments of networks, using an airborne or spaceborne vehicle for transmission. Airborne vehicles may include high altitude platforms (HAPs) such as unmanned aircraft systems (UASs) including tethered UASs, lighter-than-air UASs, and heavier-than-air UASs. Spaceborne vehicles may include satellites in orbit around the Earth, e.g., in low Earth orbit (LEO), medium Earth orbit (MEO) or geostationary Earth orbit (GEO). The airborne or spaceborne vehicle may be used for transmission by implementing a network node (e.g., base station, etc) on the airborne or spaceborne vehicle itself (e.g., such that the network node is an airborne or spaceborne network node). Thus, in such examples, a wireless device or UE communicates directly with the airborne or spaceborne network node to access the services of the network. Alternatively, the network node (e.g., base station, etc) may be implemented on the ground, but transmissions between the wireless device or UE and the network node are indirect and travel via a simple forwarding or repeating mechanism on the airborne or spaceborne vehicle. Both of these examples are discussed in more detail below.

There is an ongoing resurgence of satellite communications. Several plans for satellite networks have been announced in the past few years. The target services vary, from backhaul and fixed wireless, to transportation, to outdoor mobile, to Internet of Things (IoT). Satellite networks could complement mobile networks on the ground by providing connectivity to underserved areas and multicast/broadcast services.

To benefit from the strong mobile ecosystem and economy of scale, satellite networks for terrestrial wireless access technologies including Long Term Evolution (LTE) and New Radio (NR) are drawing significant interest. For example, the Third Generation Partnership Project (3GPP) completed an initial study in Release 15 on adapting NR to support non-terrestrial networks (mainly satellite networks); see TR 38.811, Study on New Radio (NR) to support non-terrestrial networks. This initial study focused on the channel model for the non-terrestrial networks, defining deployment scenarios, and identifying the key potential impacts. 3GPP is conducting a follow-up study item in Release 16 on solutions evaluation for NR to support non-terrestrial networks (RP-181370, Study on solutions evaluation for NR to support non-terrestrial Network).

A satellite radio access network may include one or more of the following components:
Gateway that connects satellite network to core network
Satellite that refers to a space-borne platform
Terminal that refers to user equipment
Feeder link that refers to the link between a gateway and a satellite
Service link that refers to the link between a satellite and a terminal

The link from gateway to terminal is often called forward link, and the link from terminal to gateway is often called return link. Depending on the functionality of the satellite in the system, we can consider two transponder options
Bent pipe transponder: satellite forwards the received signal back to the earth with only amplification and a shift from uplink frequency to downlink frequency.
Regenerative transponder: satellite includes on-board processing to demodulate and decode the received signal and regenerate the signal before sending it back to the Earth.

Depending on the orbit altitude, a satellite may be categorized as LEO, MEO, or GEO satellite.
LEO: typical heights ranging from 500-1,500 km, with orbital periods ranging from 10-40 minutes.
MEO: typical heights ranging from 5,000-12,000 km, with orbital periods ranging from 2-8 hours.
GEO: height at 35,786 km, with an orbital period of 24 hours.

A satellite typically generates several beams over a given area. The footprint of a beam is usually an elliptic shape, which has been traditionally considered as a cell. The footprint of a beam is also often referred to as a spotbeam. The footprint of a spotbeam may move over the Earth's surface with the satellite movement or may be fixed on the Earth's surface with some beam pointing mechanism used by the satellite to compensate for its motion. The size of a spotbeam depends on the system design, and may range from tens of kilometers to a few thousands of kilometers.

FIG. 1 shows an example architecture of a satellite network with bent pipe transponders.

The two main physical phenomena that affect satellite communications system design are the long propagation delay and Doppler effects. The Doppler effects are especially pronounced for LEO satellites.

Propagation delay is one main physical phenomenon in a satellite communication system that makes the design different from that of a terrestrial mobile system. For a bent pipe satellite network, the following delays are relevant.
One-way delay: from the base station (BS) to the user equipment (UE) via the satellite, or the other way around
Round-trip delay: from the BS to the UE via the satellite and from the UE back to the BS via the satellite
Differential delay: the delay difference of two selected points in the same spotbeam

Note that there may be additional delay between the ground BS antenna and BS, which may or may not be collocated. This delay depends on deployment. If the delay cannot be ignored, it should be taken into account in the communications system design.

The propagation delay depends on the length of the signal path, which further depends on the elevation angles of the satellite seen by the BS and UE on the ground. The minimum elevation angle is typically more than 10° for UE and more than 5° for BS on the ground.

The following Tables 1 and 2 are taken from 3GPP TR 38.811. We can see that the round-trip delay is much larger in satellite systems. For example, it is about 545 ms for a GEO satellite system. In contrast, the round-trip time is normally no more than 1 ms for typical terrestrial cellular networks.

TABLE 1
Propagation delays for GEO satellite at 35,786 km (extracted
from Table 5.3.2.1-1 in TR 38.811)

| | GEO at 35786 km | | |
|---|---|---|---|
| Elevation angle | Path | D (km) | Time (ms) |
| UE: 10° | satellite-UE | 40586 | 135.286 |
| Gateway: 5° | satellite-gateway | 41126.6 | 137.088 |
| 90° | satellite-UE | 35786 | 119.286 |

Bent Pipe satellite

| | | | |
|---|---|---|---|
| One way delay | Gateway-satellite-UE | 81712.6 | 272.375 |
| Round trip Time | Twice | 163425.3 | 544.751 |

Regenerative Satellite

| | | | |
|---|---|---|---|
| One way delay | Satellite-UE | 40586 | 135.286 |
| Round Trip Time | Satellite-UE-Satellite | 81172 | 270.572 |

TABLE 2
Propagation delays for Non-Geostationary Orbit satellites
(extracted from Table 5.3.4.1-1 in TR 38.811)

| | | LEO at 600 km | | LEO at 1500 km | | MEO at 10000 km | |
|---|---|---|---|---|---|---|---|
| Elevation | | Distance | Delay | Distance | Delay | Distance | Delay |
| angle | Path | D (km) | (ms) | D (km) | (ms) | D (km) | (ms) |
| UE: 10° | Satellite - UE | 1932.24 | 6.440 | 3647.5 | 12.158 | 14018.16 | 46.727 |
| Gateway: 5° | Satellite - | 2329.01 | 7.763 | 4101.6 | 13.672 | 14539.4 | 48.464 |
| | gateway | | | | | | |
| 90° | Satellite - UE | 600 | 2 | 1500 | 5 | 10000 | 33.333 |

Bent pipe satellite

| | | | | | | | |
|---|---|---|---|---|---|---|---|
| One way delay | Gateway - | 4261.2 | 14.204 | 7749.2 | 25.83 | 28557.6 | 95.192 |
| | satellite - UE | | | | | | |
| Round Trip | Twice | 8522.5 | 28.408 | 15498.4 | 51.661 | 57115.2 | 190.38 |
| Delay | | | | | | | |

Regenerative satellite

| | | | | | | | |
|---|---|---|---|---|---|---|---|
| One way delay | Satellite - UE | 1932.24 | 6.44 | 3647.5 | 12.16 | 14018.16 | 46.73 |
| Round Trip | Satellite - UE - | 3864.48 | 12.88 | 7295 | 24.32 | 28036.32 | 93.45 |
| Delay | Satellite | | | | | | |

Generally, within a spot beam covering one cell, the delay can be divided into a common delay component and a differential delay component. The common delay is the same for all UEs in the cell and is determined with respect to a reference point in the spot beam. In contrast, the differential delay is different for different UEs which depends on the propagation delay between the reference point and the point at which a given UE is positioned within the spot beam.

The differential delay is mainly due to the different path lengths of the access links, since the feeder link is normally the same for terminals in the same spotbeam. Further, the differential delay is mainly determined by the size of the spotbeam. It may range from sub-millisecond (for spotbeam on the order of tens of kilometres) to tens of millisecond (for spotbeam on the order of thousands of kilometres).

In RAN #80, a new study item (SI) “Solutions for NR to support Non-Terrestrial Network” was agreed. It is a continuation of a preceding SI “NR to support Non-Terrestrial Networks” (RP-171450), where the objective was to study the channel model for the non-terrestrial networks, to define deployment scenarios, parameters and identify the key potential impacts on NR. The results are reflected in TR 38.811.

The objectives of the current SI are to evaluate solutions for the identified key impacts from the preceding SI and to study impact on radio access network (RAN) protocols/architecture.

The coverage pattern of NTN is described in TR 38.811 in Section 4.6 as follows:

Satellite or aerial vehicles typically generate several beams over a given area. The foot print of the beams is typically elliptic shape.

The beam footprint may be moving over the earth with the satellite or the aerial vehicle motion on its orbit. Alternatively, the beam foot print may be earth fixed, in such case some beam pointing mechanisms (mechanical or electronic steering feature) will compensate for the satellite or the aerial vehicle motion.

TABLE 4.6-1
Typical beam foot print size

| | | Non- | |
|---|---|---|---|
| Attributes | GEO | GEO | Aerial |
| Beam foot | 200- | 100- | 5-200 |
| print size in diameter | 1000 km | 500 km | km |

Typical beam patterns of various NTN access networks are shown in FIG. 2.

The TR of the ongoing SI, TR 38.821, describes scenarios for the NTN work as follows:

Non-Terrestrial Network typically features the following elements:
One or several sat-gateways that connect the Non-Terrestrial Network to a public data network
a GEO satellite is fed by one or several sat-gateways which are deployed across the satellite targeted coverage (e.g. regional or even continental coverage). We assume that UEs in a cell are served by only one sat-gateway
A Non-GEO satellite served successively by one sat-gateway at a time. The system ensures service and feeder link continuity between the successive serving sat-gateways with sufficient time duration to proceed with mobility anchoring and hand-over

Four scenarios are considered as depicted in Table 4.2-1 and are detailed in Table 4.2-2.

TABLE 4.2-1
Reference scenarios

| | Transparent | Regenerative |
|---|---|---|
| | satellite | satellite |
| GEO based non-terrestrial | Scenario A | Scenario B |
| access network | | |
| LEO based non-terrestrial | Scenario C | Scenario D |
| access network | | |

TABLE 4.2-2
Reference scenario parameters

| | | | LEO based non-terrestrial | |
|---|---|---|---|---|
| | GEO based non-terrestrial access network | | access network (Scenario C & | |
| Scenarios | (Scenario A and B) | | D) | |
| Orbit type | Notional station keeping position fixed in | | Circular orbiting around the | |
| | terms of elevation/azimuth with respect to a | | Earth | |
| | given earth point | | | |
| Altitude | 35,786 | km | 600 | km |
| | | | 1,200 | km |
| Spectrum (service link) | <6 GHz (e.g. 2 GHz) | | | |
| | >6 GHz (e.g. DL 20 GHz, UL 30 GHz) | | | |
| Max channel bandwidth | 30 MHz for band <6 GHz | | | |
| (service link) | 400 MHz for band >6 GHz | | | |
| Payload | Scenario A: Transparent (including radio | | Scenario C: Transparent | |
| | frequency function only) | | (including radio frequency | |
| | Scenario B: regenerative (including all or | | function only) | |
| | part of RAN functions) | | Scenario D: Regenerative | |
| | | | (including all or part of RAN | |
| | | | functions) | |
| Inter-Satellite link | No | | Scenario C: No | |
| | | | Scenario D: Yes | |
| Earth-fixed beams | Yes | | Scenario C: No (the beams | |
| | | | move with the satellite) | |
| | | | Scenario D, option 1: Yes | |
| | | | (steering beams), see note 1 | |
| | | | Scenario D, option 2: No (the | |
| | | | beams move with the satellite) | |
| Max beam foot print diameter at | 500 | km | 200 | km |
| nadir | | | | |
| Min Elevation angle for both | 10° | | 10° | |
| sat-gateway and user | | | | |
| equipment | | | | |
| Max distance between satellite | 40,586 | km | 1,932 km (600 km altitude) | |
| and user equipment at min | | | 3,131 km (1,200 km altitude) | |
| elevation angle | | | | |
| Max Round Trip Delay | Scenario A: 562 ms (service and feeder | | Scenario C: 25.76 ms | |
| (propagation delay only) | links) | | (transparent payload: service | |
| | Scenario B: 281 ms | | and feeder links) | |
| | | | Scenario D: 12.88 ms | |
| | | | (regenerative payload: service | |
| | | | link only) | |
| Max delay variation within a | 16 | ms | 4.44 ms (600 km) | |
| beam (earth fixed user | | | 6.44 ms (1200 km) | |
| equipment) | | | | |
| Max differential delay within a | 1.6 | ms | 0.65 | ms (*) |
| beam | | | | |
| Max Doppler shift (earth fixed | 0.93 | ppm | 24 | ppm (*) |
| user equipment) | | | | |
| Max Doppler shift variation | 0.000 045 | ppm/s | 0.27 | ppm/s (*) |

| (earth fixed user equipment) | | |
|---|---|---|
| User equipment motion on the | 1000 km/h (e.g. aircraft) | 500 km/h (e.g. high speed |
| earth | | train) |
| | | Possibly 1000 km/h (e.g. |
| | | aircraft) |
| User equipment antenna types | Omnidirectional antenna (linear polarisation), assuming 0 dBi | |
| | Directive antenna (up to 60 cm equivalent aperture diameter in circular | |
| | polarisation) | |
| User equipment Tx power | Omnidirectional antenna: UE power class 3 with up to 200 mW | |
| | Directive antenna: up to 4 W | |
| User equipment Noise figure | Omnidirectional antenna: 7 dB | |
| | Directive antenna: 1.2 dB | |
| Service link | 3GPP defined New Radio | |
| Feeder link | 3GPP or non-3GPP defined Radio | 3GPP or non-3GPP defined |
| | interface | Radio interface |

NOTE 1:
Each satellite has the capability to steer beams towards fixed points on earth using beamforming techniques. This is applicable for a period of time corresponding to the visibility time of the satellite
NOTE 2:
Max delay variation within a beam (earth fixed user equipment) is calculated based on Min Elevation angle for both gateway and user equipment
NOTE 3:
Max differential delay within a beam is calculated based on Max beam foot print diameter at nadir

For scenario D, which is LEO with regenerative payload, both Earth-fixed and Earth-moving beams have been listed. So, when we factor in the fixed/non-fixed beams, we have an additional scenario. The complete list of 5 scenarios in 3GPP TR 38.821 is then:

Scenario A—GEO, transparent satellite, Earth-fixed beams;

Scenario B—GEO, regenerative satellite, Earth fixed beams;

Scenario C—LEO, transparent satellite, Earth-moving beams;

Scenario D1—LEO, regenerative satellite, Earth-fixed beams;

Scenario D2—LEO, regenerative satellite, Earth-moving beams.

A UE in connected mode is typically configured to measure and report the radio environment in its serving cell and neighboring cells. When the quality of the serving cell is below a certain threshold and the quality of a neighbor cell is above, the network may instruct the UE to perform a Hand Over (HO) by sending a HO command to the UE which then drops the connection to the serving cell (source) and initiates access to the neighbor (target) cell. During the attach procedure to the target cell, which could include synchronization, reading system information and the access attempt, the UE is interrupted from uplink (UL) and downlink (DL) transmission until the connection to the target cell is established.

In later LTE releases, this procedure has been optimized to allow the UE to keep its connection to the source cell until the actual access attempt is initiated, i.e. when the random-access preamble is transmitted in the target cell. This allows for a decreased interruption time so that the UE can maintain data transaction for a longer time. When the UE, as part of the handover procedure, performs a first transmission to the target cell it will first release its connection to the source cell.

There currently exist certain challenge(s).

Existing mobility procedures have been designed for terrestrial networks where the round-trip/propagation delay is restricted to be within one or a few milliseconds. For UEs in cells experiencing longer delays, e.g. such as a satellite communication system, the interruption time at HO is related to the propagation delay.

A UE connected to a non-terrestrial network (NTN), e.g. a GEO satellite system, may experience a round-trip time (RTT) around 550 ms which will interrupt the data transmission for several RTTs before the connections are up and running with the target Cell.

FIG. 3 shows the various delays associated with data transactions:
1. The packet first reaches the receiver after a propagation delay Tp.
2. The receiver sends the feedback or response after a processing/slot delay T1.
3. The feedback/response reaches the transmitter after a propagation delay Tp.
4. The transmitter may send a retransmission or new data after a processing/slot delay T2.

5. The total delay is (2Tp+T1+T2).

We now highlight the main issues with existing HO process for cells with large propagation delays.
1. The existing HO mechanism will suffer from large interruptions when the propagation delay is larger than for a typical terrestrial network. The large propagation delays will cause the UE to experience long interruption times, resulting in a degraded end user experience with reduced bitrates and service degradations.
2. During the interruption, the source Cell may need to forward all incoming DL packets to the target Cell which may increase the memory requirements on both the gateway and satellite. The same is also valid for UL packets, with the UE needing to buffer all data until the connection to the target cell is completed.

In short, the existing HO mechanism is ill-suited to networks with large propagation delays, such as NTNs.

### SUMMARY

Certain aspects of the present disclosure and their embodiments may provide solutions to these or other challenges.

The proposed solutions introduce methods enabling a UE to maintain the connection to the source cell during a handover to a target cell suffering from long (propagation) delays, thus allowing for continued data reception/transmission in the source cell while the UE is not able to receive/transmit in the target cell. The use of the source cell connection may be limited to only some occasions, such as occasions where the UE is waiting for a response from the target cell, allowing the source cell connection to be maintained/used even by a UE without dual connection capability. The use of the source cell connection during the handover, including what specific occasions it shall be used, may be configured by the network.

There are, proposed herein, various embodiments which address one or more of the issues disclosed herein.

One aspect of the disclosure provides a method performed by a wireless device for performing handover from a source network node to a target network node. The method comprises: obtaining an indication of a round-trip time for transmissions to the target network node; initiating access to the target network node; and, subsequent to initiating access to the target network node, transmitting data to or receiving data from the source network node for a time window following initiation of access to the target network node. The time window has a duration of at least the round-trip time for transmissions to the target network node.

Apparatus for performing the method set out above is also provided. For example, in one aspect there is provided a wireless device. The wireless device comprises: power supply circuitry configured to supply power to the wireless device; and processing circuitry configured to, when performing handover of the wireless device from a source network node to a target network node: obtain an indication of a round-trip time for transmissions to the target network node; initiate access to the target network node; and, subsequent to initiating access to the target network node, transmit data to or receive data from the source network node for a time window following initiation of access to the target network node. The time window has a duration of at least the round-trip time for transmissions to the target network node.

A further aspect of the disclosure provides a method performed by a source network node during handover of a wireless device from the source network node to a target network node. The method comprises: obtaining an indication of a round-trip time for transmissions from the wireless device to the target network node; and, subsequent to the wireless device initiating access to the target network node, transmitting data to or receiving data from the wireless device for a time window following the initiation of access to the target network node. The time window has a duration of at least the round-trip time for transmissions from the wireless device to the target network node.

Apparatus for performing the method set out above is also provided. For example, in one aspect there is provided a network node. The network node comprises processing circuitry configured to, when performing handover of a wireless device from the network node, acting as source network node, to a target network node: obtain an indication of a round-trip time for transmissions from the wireless device to the target network node; and, subsequent to the wireless device initiating access to the target network node, transmit data to or receive data from the wireless device for a time window following the initiation of access to the target network node. The time window has a duration of at least the round-trip time for transmissions from the wireless device to the target network node.

Another aspect of the disclosure provides a method performed by a target network node relating to handover of a wireless device from a source network node to the target network node. The method comprises: causing transmission, to the source network node, of an indication of a time window following initiation of access to the target network node by the wireless device, in which the source network node is to transmit data to or receive data from the wireless device.

Apparatus for performing the method set out above is also provided. For example, in one aspect there is provided a network node. The network node comprises processing circuitry configured to, when performing handover of a wireless device to the network node, acting as a target network node, from a source network node: cause transmission, to the source network node, of an indication of a time window following initiation of access to the network node by the wireless device, in which the source network node is to transmit data to or receive data from the wireless device.

Certain embodiments may provide one or more technical advantage(s), including significantly decreased interruption times at handovers to a target cell that is suffering from long delays, such as cells belonging to a non-terrestrial network. Certain embodiments may also limit the memory requirements on the network nodes and UEs in a satellite system and improve the end-to-end user experience.

### BRIEF DESCRIPTION OF THE DRAWINGS

FIG. 1 shows an example architecture of a satellite network with bent pipe transponders;

FIG. 2 shows the typical beam patterns of various NTN access networks;

FIG. 3 shows propagation and processing delays associated with data transactions;

FIG. 4 shows two signalling diagrams during handover;

FIG. 5 shows a wireless network according to embodiments of the disclosure;

FIG. 6 shows a user equipment according to embodiments of the disclosure;

FIG. 7 shows a virtualization environment according to embodiments of the disclosure;

FIG. 8 shows a telecommunication network connected via an intermediate network to a host computer according to embodiments of the disclosure;

FIG. 9 shows a host computer communicating via a base station with a user equipment over a partially wireless connection according to embodiments of the disclosure;

FIGS. 10 to 13 show methods implemented in a communication system including a host computer, a base station and a user equipment according to embodiments of the disclosure;

FIG. 14 is a flowchart of a method in a wireless device according to embodiments of the disclosure;

FIG. 15 shows a virtualization apparatus according to embodiments of the disclosure;

FIG. 16 is a flowchart of a method in a source base station according to embodiments of the disclosure;

FIG. 17 shows a virtualization apparatus according to embodiments of the disclosure;

FIG. 18 is a flowchart of a method in a target base station according to embodiments of the disclosure; and

FIG. 19 shows a virtualization apparatus according to embodiments of the disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

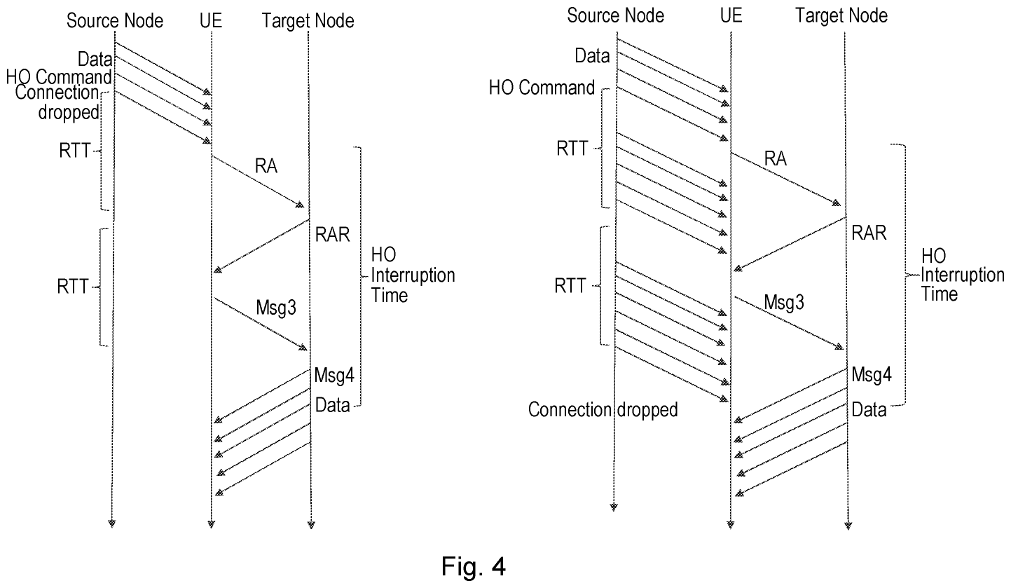

According to embodiments of the disclosure, the UE maintains its connection to the source cell, after it has initiated access to the target cell, by performing receptions/transmissions in the source cell while waiting (due to target cell RTT) for responses in the target cell. This allows the UE to perform reception and/or transmission in one of the cells at a time but still continue reception/transmission in the source cell after initiating access in the target cell. This concept is illustrated in the signaling diagrams of FIG. 4.

The left-hand side of FIG. 4 shows signaling during handover in Long Term Evolution. The UE initially receives data from the source network node before then receiving a handover command or trigger from the source network node (alternatively the UE may request handover). At that point, data transmissions between the source network node and the UE are halted. The UE transmits a random access message (e.g., a random access preamble) to the target network node, which responds with a Random Access Response message. In the illustrated example, access to the target network node is via contention-based random access, and thus a further message (Msg3) is transmitted to the target network node to resolve any contention with other UEs seeking to access the target network node. In the illustration, any contention is resolved in the UE's favour, and the target network node transmits a further message (Msg4) to the UE to complete the establishment of a connection between the UE and the target network node. Data can thereafter be transmitted between the UE and the target network node (with DL data shown in the Figure). As can be seen, this results in a significant interruption to services during the handover.

The right-hand side of FIG. 4 shows a similar scenario (e.g., handover to a target network node implementing contention-based random access), but according to embodiments of the disclosure.

After the source network node transmits the handover command or trigger to the UE (and/or the UE requests handover), the connection between the source network node and the UE remains valid and data continues to be transmitted between them. The illustrated embodiment shows only DL data being transmitted from the source network node to the UE, although those skilled in the art will appreciate that UL data may additionally or alternatively be transmitted from the UE to the source network node. Those skilled in the art will also appreciate that the transmissions may utilize radio resources which are scheduled or granted via transmissions on a control channel such as the Physical Downlink Control Channel (PDCCH), e.g., via Downlink Control Information (DCI) messages.

The data transmissions between the source network node and the UE may continue for a time window after access has been initiated to the target network node (e.g., a RA message has been transmitted). The time window may extend for approximately one RTT in the target network node (e.g., for non-contention-based random access in the target cell) or, as in the illustrated embodiment, approximately two RTTs in the target network node (e.g., for contention-based random access). After the time window has ended, the transmissions between the UE and the source network node may cease, with further data transmissions taking place between the UE and the target network node.

It will be noted that at certain times during the time window, no data transmissions take place between the UE and the source network node. These times may correspond to those times at which the UE is performing transmissions in the target cell, e.g., as part of the random access procedure. For example, the times may correspond to times at which the UE is monitoring for a random access response message (RAR or Msg2) from the target network node. Thus the time window may comprise one or more breaks in which data transmissions between the UE and the source network node do not take place.

One possible implementation of this embodiment is described as follows.

After the source network node sends the HO command to the UE, it continues UL and DL communication (e.g., on the Physical Uplink Shared Channel (PUSCH) and the Physical Downlink Shared Channel (PDSCH), respectively) by indicating uplink grants or downlink assignments on the PDCCH. In one embodiment, the UE monitors PDCCH for UL/DL traffic in the source cell according to the serving cell configuration prior to HO command (which may include specific PDCCH/Coreset configuration for this purpose). Any preconfigured transmission such as measurement reports, configured scheduling etc. may also be maintained in the source cell.

The UE consequently monitors and receives in the DL and transmits in the UL of the source cell continuously with the exception for when it needs to perform a transmission or reception in the target cell that makes it unable to monitor the DL or transmit in the UL in the source cell at the same time. For example, after transmission of the random-access preamble (Msg1) to the target network node, the UE may monitor (including receive/transmit in) the source cell connection during the time period of around one RTT in the target cell, since during that time it will not receive Random Access Response (RAR) message (Msg2) in the target cell, see FIG. 4. The duration of this time period, i.e. the waiting time T, consists of the propagation delay (Tp) in the uplink+the delay in the target network node (processing time and slot time)+the propagation delay (Tp) in the downlink. In case of a so called non-terrestrial network, the propagation delay (Tp) will depend on the actual distance between the UE and the satellite containing the network node, or the network node may even be placed on the ground in the case of a transparent satellite. There is however a minimum propagation delay, which is based on the distance between the network node and the closest possible position where the UE may be placed (on earth or e.g. on an airplane).

The UE should thus be informed about the minimum propagation delay and/or the minimum waiting time T for the target cell during the handover procedure (before initiating the access in the target cell) or before the start of the handover procedure. For example, the UE may be informed about the target cell minimum propagation delay and/or minimum waiting time T in the Handover Command message, which may be included in the RRCConnectionReconfiguration message in LTE or the RRCReconfiguration message in NR. Alternatively, the value of the target cell minimum propagation delay and/or minimum waiting time T may be broadcasted in target cell system information.

In some embodiments, the source network node may take into account knowledge of when the UE may be occupied by sending/receiving in the target cell, for UL/DL communication in the source cell (e.g., when indicating uplink grants or downlink assignments on the PDCCH). For example, the source network node may be informed of the Random Access occasions in the target cell and pause any scheduling during such occasions in order to avoid lost packets/resources. The source network node may be informed about the target cell's access information during the handover procedure, e.g. in the Handover Request Ack message from the target network node or the wireless device.

In case contention based random access (CBRA) is used in the target cell the UE needs to send Msg3 and then wait for a time period related to the RTT (or T) in the target cell before it receives confirmation from the target node (Msg4) that completes the contention resolution. No transmission/reception can therefore typically be performed in the target cell until Msg4 has been received. During this wait time, i.e. between transmission of Msg3 and reception of Msg4, the UE can then continue its connection with the source cell and reduce the interruption even further.

After the HO command is sent to the UE, configuring a HO using CBRA in the target cell (node), the source node continues to schedule the UE for a time period of 3/2 RTT ms or until notified. The source node then pauses transmissions to and/or scheduling of the UE for the length of the RAR window of the target cell, knowing that the UE will then be monitoring the target Cell. The source node then restarts the transmission to and/or scheduling of the UE for RTT ms while the UE waits for Msg4 from the target cell. The source node may be informed that the HO includes use of CBRA in the target cell from the target node in the HO Request Ack message, or by checking the HO Command message (e.g. RRCConnnectionReconfiguration or RRCReconfiguration). As an alternative, the source node is informed by the UE about the use of CBRA in the target cell during the HO. The source node may also be informed about the RTT that is applicable for the UE in the target cell (node) through the same mechanisms. After handover is complete, data may be transmitted or received in the target cell by monitoring PDCCH for UL/DL traffic according to RRCreconfiguration received in the HO command (which may contain a specific PDCCH/Coreset configuration for this).

In a further embodiment, the UE may transmit to the source node an indication of when the preamble was sent in the target cell so that the source node can make a more accurate estimation of the start and end of the RTT period in the target Cell. The UE may also transmit an indication of when Msg3 was sent in the target cell if four-step random access (e.g., contention based random access) is used in the target cell. This would avoid scheduling of the UE that will not be received.

Alternatively, the source node may receive this information from the target node. For example, for contention free random access, the target node may inform the source node when the preamble is received or RAR sent (and/or when Msg3 is received or Msg4 sent). If both source and target network nodes are on the ground, this information may be exchanged over a direct interface between the source and target network nodes (e.g., Xn).

In a further alternative or additional embodiment, the status of the ongoing handover may be indicated by the target network node to the source network node over a direct interface (e.g., Xn). The status may be indicated in a new message. In this way, the target node may thus inform the source node about how long to keep the connection to the UE, e.g., to continue with transmissions to and/or UL scheduling and reception from the UE for the time window, and when the source node should pause such connection (DL transmissions, UL scheduling and/or reception) due to the UE being active in the target cell (e.g., the breaks in the time window described above).

Alternatively the UE can be configured, e.g. using a control message (such as a radio resource control (RRC) message), to indicate to the source node when the UE will be active in the target cell (node) during the handover procedure, and when the source node should pause the connection to the UE.

The UE can be configured to perform the here proposed solution, i.e. to return to the source cell (node) when it is waiting for response from the target node, or while waiting for an occasion to transmit during the HO procedure, with an indication in the HO Command message (e.g. RRCConnnectionReconfiguration or RRCReconfiguration). As an alternative the activation (of this minimum interruption procedure) could also be by using a new Medium Access Control (MAC) Control Element (CE) or indicated in the DCI sent to indicate the transmitted HO command message.

As an alternative, the UE indicates that it supports a return to the source cell (node) when it e.g. is waiting for response from the target node during the HO procedure through a UE capability indication.

In a yet further embodiment, the source node may communicate to the target node which data packets (e.g., Packet Data Convergence Protocol (PDCP) packets), sequence numbers (SNs), range of SNs, it is still attempting to deliver to the UE. This can be per bearer, or Quality of Service (QoS) flow or Protocol Data Unit (PDU) session. This can be done separately or together with normal data forwarding between the nodes. Further the source network node may also communicate later which packets are delivered successfully. Or, the UE may be configured to send a status report directly to the target network node comprising an indication of successfully delivered data packets from the source network node.

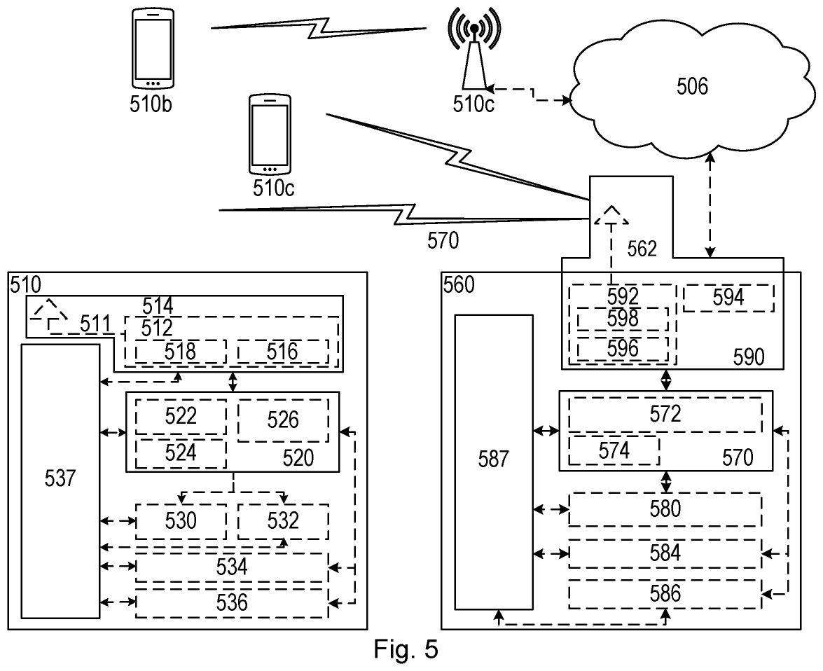

Although the subject matter described herein may be implemented in any appropriate type of system using any suitable components, the embodiments disclosed herein are described in relation to a wireless network, such as the example wireless network illustrated in FIG. 5. For simplicity, the wireless network of FIG. 5 only depicts network 506, network nodes 560 and 560b, and WDs 510, 510b, and 510c. In practice, a wireless network may further include any additional elements suitable to support communication between wireless devices or between a wireless device and another communication device, such as a landline telephone, a service provider, or any other network node or end device. Of the illustrated components, network node 560 and wireless device (WD) 510 are depicted with additional detail. The wireless network may provide communication and other types of services to one or more wireless devices to facilitate the wireless devices' access to and/or use of the services provided by, or via, the wireless network.

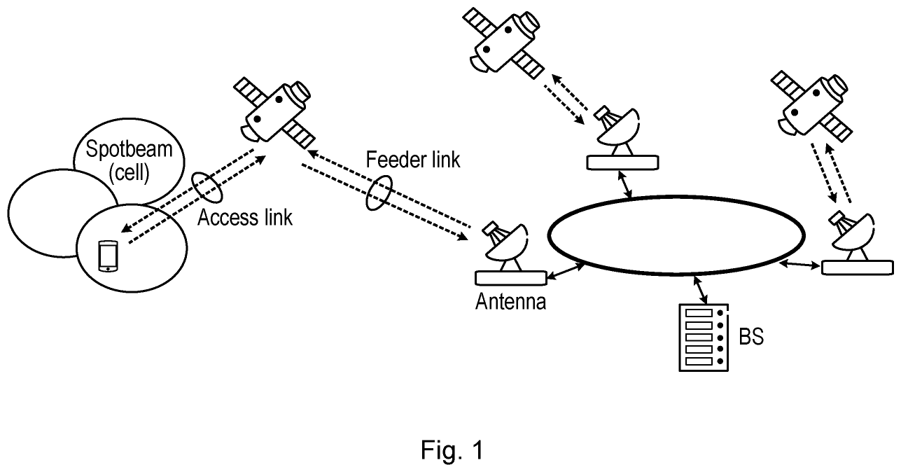

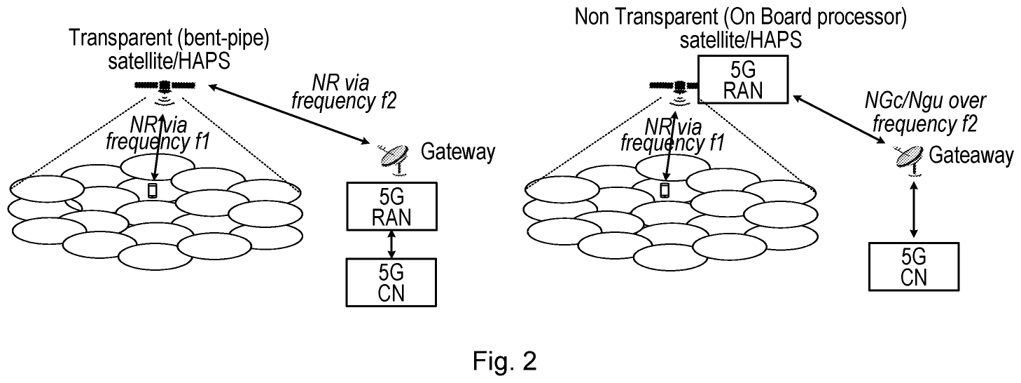

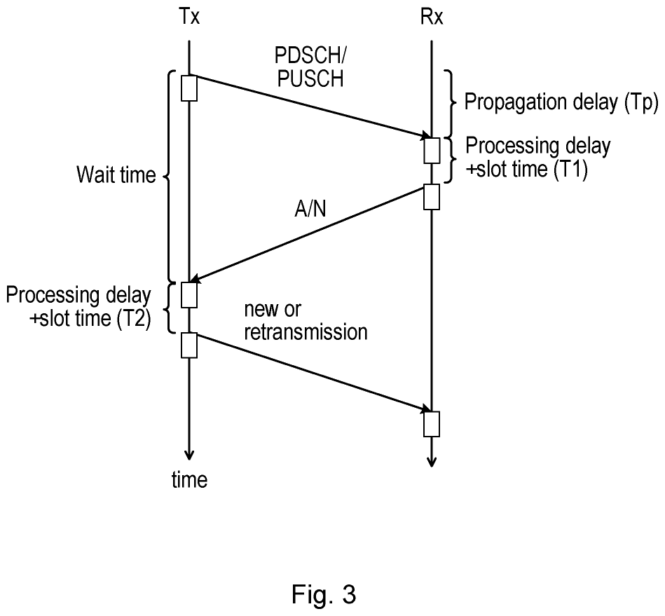

According to embodiments of the disclosure, at least one of the network nodes 560 belongs to a non-terrestrial network, such that transmissions between a wireless device 510 and the at least one network node 560 pass via an airborne or spaceborne vehicle. As noted above, the airborne or spaceborne vehicle may be used for transmission by implementing the at least one network node 560 on the airborne or spaceborne vehicle itself (e.g., such that the network node is an airborne or spaceborne network node). Thus, in such examples, a wireless device or UE communicates directly with the airborne or spaceborne network node to access the services of the network. Alternatively, the at least one network node 560 may be implemented on the ground, but transmissions between the wireless device or UE and the network node are indirect and travel via a simple forwarding or repeating mechanism on the airborne or spaceborne vehicle (not illustrated in FIG. 5, but see FIG. 1 above).

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 506 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 560 and WD 510 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node 560 includes processing circuitry 570, device readable medium 580, interface 590, auxiliary equipment 584, power source 586, power circuitry 587, and antenna 562. Although network node 560 illustrated in the example wireless network of FIG. 5 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 560 are depicted as single boxes located within a larger box, or nested within multiple boxes, in practice, a network node may comprise multiple different physical components that make up a single illustrated component (e.g., device readable medium 580 may comprise multiple separate hard drives as well as multiple RAM modules).

Similarly, network node 560 may be composed of multiple physically separate components (e.g., a NodeB component and a RNC component, or a BTS component and a BSC component, etc.), which may each have their own respective components. In certain scenarios in which network node 560 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 560 may be configured to support multiple radio access technologies (RATs). In such embodiments, some components may be duplicated (e.g., separate device readable medium 580 for the different RATs) and some components may be reused (e.g., the same antenna 562 may be shared by the RATs). Network node 560 may also include multiple sets of the various illustrated components for different wireless technologies integrated into network node 560, such as, for example, GSM, WCDMA, LTE, NR, WiFi, or Bluetooth wireless technologies. These wireless technologies may be integrated into the same or different chip or set of chips and other components within network node 560.

Processing circuitry 570 is configured to perform any determining, calculating, or similar operations (e.g., certain obtaining operations) described herein as being provided by a network node. These operations performed by processing circuitry 570 may include processing information obtained by processing circuitry 570 by, for example, converting the obtained information into other information, comparing the obtained information or converted information to information stored in the network node, and/or performing one or more operations based on the obtained information or converted information, and as a result of said processing making a determination.

Processing circuitry 570 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 560 components, such as device readable medium 580, network node 560 functionality. For example, processing circuitry 570 may execute instructions stored in device readable medium 580 or in memory within processing circuitry 570. Such functionality may include providing any of the various wireless features, functions, or benefits discussed herein. In some embodiments, processing circuitry 570 may include a system on a chip (SOC).

In some embodiments, processing circuitry 570 may include one or more of radio frequency (RF) transceiver circuitry 572 and baseband processing circuitry 574. In some embodiments, radio frequency (RF) transceiver circuitry 572 and baseband processing circuitry 574 may be on separate chips (or sets of chips), boards, or units, such as radio units and digital units. In alternative embodiments, part or all of RF transceiver circuitry 572 and baseband processing circuitry 574 may be on the same chip or set of chips, boards, or units

In certain embodiments, some or all of the functionality described herein as being provided by a network node, base station, eNB or other such network device may be performed by processing circuitry 570 executing instructions stored on device readable medium 580 or memory within processing circuitry 570. In alternative embodiments, some or all of the functionality may be provided by processing circuitry 570 without executing instructions stored on a separate or discrete device readable medium, such as in a hard-wired manner. In any of those embodiments, whether executing instructions stored on a device readable storage medium or not, processing circuitry 570 can be configured to perform the described functionality. The benefits provided by such functionality are not limited to processing circuitry 570 alone or to other components of network node 560, but are enjoyed by network node 560 as a whole, and/or by end users and the wireless network generally.

Device readable medium 580 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 570. Device readable medium 580 may store any suitable instructions, data or information, including a computer program, software, an application including one or more of logic, rules, code, tables, etc. and/or other instructions capable of being executed by processing circuitry 570 and, utilized by network node 560. Device readable medium 580 may be used to store any calculations made by processing circuitry 570 and/or any data received via interface 590. In some embodiments, processing circuitry 570 and device readable medium 580 may be considered to be integrated.

Interface 590 is used in the wired or wireless communication of signalling and/or data between network node 560, network 506, and/or WDs 510. As illustrated, interface 590 comprises port(s)/terminal(s) 594 to send and receive data, for example to and from network 506 over a wired connection. Interface 590 also includes radio front end circuitry 592 that may be coupled to, or in certain embodiments a part of, antenna 562. Radio front end circuitry 592 comprises filters 598 and amplifiers 596. Radio front end circuitry 592 may be connected to antenna 562 and processing circuitry 570. Radio front end circuitry may be configured to condition signals communicated between antenna 562 and processing circuitry 570. Radio front end circuitry 592 may receive digital data that is to be sent out to other network nodes or WDs via a wireless connection. Radio front end circuitry 592 may convert the digital data into a radio signal having the appropriate channel and bandwidth parameters using a combination of filters 598 and/or amplifiers 596. The radio signal may then be transmitted via antenna 562. Similarly, when receiving data, antenna 562 may collect radio signals which are then converted into digital data by radio front end circuitry 592. The digital data may be passed to processing circuitry 570. In other embodiments, the interface may comprise different components and/or different combinations of components.

In certain alternative embodiments, network node 560 may not include separate radio front end circuitry 592, instead, processing circuitry 570 may comprise radio front end circuitry and may be connected to antenna 562 without separate radio front end circuitry 592. Similarly, in some embodiments, all or some of RF transceiver circuitry 572 may be considered a part of interface 590. In still other embodiments, interface 590 may include one or more ports or terminals 594, radio front end circuitry 592, and RF transceiver circuitry 572, as part of a radio unit (not shown), and interface 590 may communicate with baseband processing circuitry 574, which is part of a digital unit (not shown).

Antenna 562 may include one or more antennas, or antenna arrays, configured to send and/or receive wireless signals. Antenna 562 may be coupled to radio front end circuitry 590 and may be any type of antenna capable of transmitting and receiving data and/or signals wirelessly. In some embodiments, antenna 562 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 562 may be separate from network node 560 and may be connectable to network node 560 through an interface or port.

Antenna 562, interface 590, and/or processing circuitry 570 may be configured to perform any receiving operations and/or certain obtaining operations described herein as being performed by a network node. Any information, data and/or signals may be received from a wireless device, another network node and/or any other network equipment. Similarly, antenna 562, interface 590, and/or processing circuitry 570 may be configured to perform any transmitting operations described herein as being performed by a network node. Any information, data and/or signals may be transmitted to a wireless device, another network node and/or any other network equipment.

Power circuitry 587 may comprise, or be coupled to, power management circuitry and is configured to supply the components of network node 560 with power for performing the functionality described herein. Power circuitry 587 may receive power from power source 586. Power source 586 and/or power circuitry 587 may be configured to provide power to the various components of network node 560 in a form suitable for the respective components (e.g., at a voltage and current level needed for each respective component). Power source 586 may either be included in, or external to, power circuitry 587 and/or network node 560. For example, network node 560 may be connectable to an external power source (e.g., an electricity outlet) via an input circuitry or interface such as an electrical cable, whereby the external power source supplies power to power circuitry 587. As a further example, power source 586 may comprise a source of power in the form of a battery or battery pack which is connected to, or integrated in, power circuitry 587. The battery may provide backup power should the external power source fail. Other types of power sources, such as photovoltaic devices, may also be used.

Alternative embodiments of network node 560 may include additional components beyond those shown in FIG. 5 that may be responsible for providing certain aspects of the network node's functionality, including any of the functionality described herein and/or any functionality necessary to support the subject matter described herein. For example, network node 560 may include user interface equipment to allow input of information into network node 560 and to allow output of information from network node 560. This may allow a user to perform diagnostic, maintenance, repair, and other administrative functions for network node 560.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (Vol P) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 510 includes antenna 511, interface 514, processing circuitry 520, device readable medium 530, user interface equipment 532, auxiliary equipment 534, power source 536 and power circuitry 537. WD 510 may include multiple sets of one or more of the illustrated components for different wireless technologies supported by WD 510, such as, for example, GSM, WCDMA, LTE, NR, WiFi, WiMAX, or Bluetooth wireless technologies, just to mention a few. These wireless technologies may be integrated into the same or different chips or set of chips as other components within WD 510.

Antenna 511 may include one or more antennas or antenna arrays, configured to send and/or receive wireless signals, and is connected to interface 514. In certain alternative embodiments, antenna 511 may be separate from WD 510 and be connectable to WD 510 through an interface or port. Antenna 511, interface 514, and/or processing circuitry 520 may be configured to perform any receiving or transmitting operations described herein as being performed by a WD. Any information, data and/or signals may be received from a network node and/or another WD. In some embodiments, radio front end circuitry and/or antenna 511 may be considered an interface.

As illustrated, interface 514 comprises radio front end circuitry 512 and antenna 511. Radio front end circuitry 512 comprise one or more filters 518 and amplifiers 516. Radio front end circuitry 514 is connected to antenna 511 and processing circuitry 520, and is configured to condition signals communicated between antenna 511 and processing circuitry 520. Radio front end circuitry 512 may be coupled to or a part of antenna 511. In some embodiments, WD 510 may not include separate radio front end circuitry 512; rather, processing circuitry 520 may comprise radio front end circuitry and may be connected to antenna 511. Similarly, in some embodiments, some or all of RF transceiver circuitry 522 may be considered a part of interface 514. Radio front end circuitry 512 may receive digital data that is to be sent out to other network nodes or WDs via a wireless connection. Radio front end circuitry 512 may convert the digital data into a radio signal having the appropriate channel and bandwidth parameters using a combination of filters 518 and/or amplifiers 516. The radio signal may then be transmitted via antenna 511. Similarly, when receiving data, antenna 511 may collect radio signals which are then converted into digital data by radio front end circuitry 512. The digital data may be passed to processing circuitry 520. In other embodiments, the interface may comprise different components and/or different combinations of components.

Processing circuitry 520 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 510 components, such as device readable medium 530, WD 510 functionality. Such functionality may include providing any of the various wireless features or benefits discussed herein. For example, processing circuitry 520 may execute instructions stored in device readable medium 530 or in memory within processing circuitry 520 to provide the functionality disclosed herein.

As illustrated, processing circuitry 520 includes one or more of RF transceiver circuitry 522, baseband processing circuitry 524, and application processing circuitry 526. In other embodiments, the processing circuitry may comprise different components and/or different combinations of components. In certain embodiments processing circuitry 520 of WD 510 may comprise a SOC. In some embodiments, RF transceiver circuitry 522, baseband processing circuitry 524, and application processing circuitry 526 may be on separate chips or sets of chips. In alternative embodiments, part or all of baseband processing circuitry 524 and application processing circuitry 526 may be combined into one chip or set of chips, and RF transceiver circuitry 522 may be on a separate chip or set of chips. In still alternative embodiments, part or all of RF transceiver circuitry 522 and baseband processing circuitry 524 may be on the same chip or set of chips, and application processing circuitry 526 may be on a separate chip or set of chips. In yet other alternative embodiments, part or all of RF transceiver circuitry 522, baseband processing circuitry 524, and application processing circuitry 526 may be combined in the same chip or set of chips. In some embodiments, RF transceiver circuitry 522 may be a part of interface 514. RF transceiver circuitry 522 may condition RF signals for processing circuitry 520.

In certain embodiments, some or all of the functionality described herein as being performed by a WD may be provided by processing circuitry 520 executing instructions stored on device readable medium 530, which in certain embodiments may be a computer-readable storage medium. In alternative embodiments, some or all of the functionality may be provided by processing circuitry 520 without executing instructions stored on a separate or discrete device readable storage medium, such as in a hard-wired manner. In any of those particular embodiments, whether executing instructions stored on a device readable storage medium or not, processing circuitry 520 can be configured to perform the described functionality. The benefits provided by such functionality are not limited to processing circuitry 520 alone or to other components of WD 510, but are enjoyed by WD 510 as a whole, and/or by end users and the wireless network generally.

Processing circuitry 520 may be configured to perform any determining, calculating, or similar operations (e.g., certain obtaining operations) described herein as being performed by a WD. These operations, as performed by processing circuitry 520, may include processing information obtained by processing circuitry 520 by, for example, converting the obtained information into other information, comparing the obtained information or converted information to information stored by WD 510, and/or performing one or more operations based on the obtained information or converted information, and as a result of said processing making a determination.

Device readable medium 530 may be operable to store a computer program, software, an application including one or more of logic, rules, code, tables, etc. and/or other instructions capable of being executed by processing circuitry 520. Device readable medium 530 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 520. In some embodiments, processing circuitry 520 and device readable medium 530 may be considered to be integrated.

User interface equipment 532 may provide components that allow for a human user to interact with WD 510. Such interaction may be of many forms, such as visual, audial, tactile, etc. User interface equipment 532 may be operable to produce output to the user and to allow the user to provide input to WD 510. The type of interaction may vary depending on the type of user interface equipment 532 installed in WD 510. For example, if WD 510 is a smart phone, the interaction may be via a touch screen; if WD 510 is a smart meter, the interaction may be through a screen that provides usage (e.g., the number of gallons used) or a speaker that provides an audible alert (e.g., if smoke is detected). User interface equipment 532 may include input interfaces, devices and circuits, and output interfaces, devices and circuits. User interface equipment 532 is configured to allow input of information into WD 510, and is connected to processing circuitry 520 to allow processing circuitry 520 to process the input information. User interface equipment 532 may include, for example, a microphone, a proximity or other sensor, keys/buttons, a touch display, one or more cameras, a USB port, or other input circuitry. User interface equipment 532 is also configured to allow output of information from WD 510, and to allow processing circuitry 520 to output information from WD 510. User interface equipment 532 may include, for example, a speaker, a display, vibrating circuitry, a USB port, a headphone interface, or other output circuitry. Using one or more input and output interfaces, devices, and circuits, of user interface equipment 532, WD 510 may communicate with end users and/or the wireless network, and allow them to benefit from the functionality described herein.

Auxiliary equipment 534 is operable to provide more specific functionality which may not be generally performed by WDs. This may comprise specialized sensors for doing measurements for various purposes, interfaces for additional types of communication such as wired communications etc. The inclusion and type of components of auxiliary equipment 534 may vary depending on the embodiment and/or scenario.

Power source 536 may, in some embodiments, be in the form of a battery or battery pack. Other types of power sources, such as an external power source (e.g., an electricity outlet), photovoltaic devices or power cells, may also be used. WD 510 may further comprise power circuitry 537 for delivering power from power source 536 to the various parts of WD 510 which need power from power source 536 to carry out any functionality described or indicated herein. Power circuitry 537 may in certain embodiments comprise power management circuitry. Power circuitry 537 may additionally or alternatively be operable to receive power from an external power source; in which case WD 510 may be connectable to the external power source (such as an electricity outlet) via input circuitry or an interface such as an electrical power cable. Power circuitry 537 may also in certain embodiments be operable to deliver power from an external power source to power source 536. This may be, for example, for the charging of power source 536. Power circuitry 537 may perform any formatting, converting, or other modification to the power from power source 536 to make the power suitable for the respective components of WD 510 to which power is supplied.

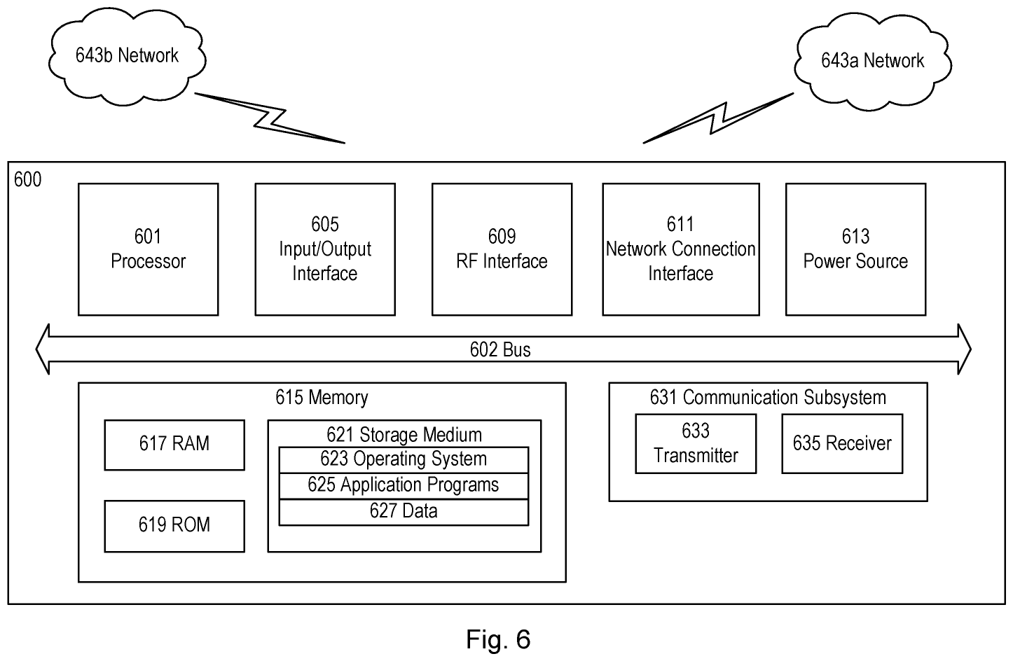

FIG. 6 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 6200 may be any UE identified by the 3^{rd} Generation Partnership Project (3GPP), including a NB-IoT UE, a machine type communication (MTC) UE, and/or an enhanced MTC (eMTC) UE. UE 600, as illustrated in FIG. 6, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 6 is a UE, the components discussed herein are equally applicable to a WD, and vice-versa.

In FIG. 6, UE 600 includes processing circuitry 601 that is operatively coupled to input/output interface 605, radio frequency (RF) interface 609, network connection interface 611, memory 615 including random access memory (RAM) 617, read-only memory (ROM) 619, and storage medium 621 or the like, communication subsystem 631, power source 633, and/or any other component, or any combination thereof. Storage medium 621 includes operating system 623, application program 625, and data 627. In other embodiments, storage medium 621 may include other similar types of information. Certain UEs may utilize all of the components shown in FIG. 6, or only a subset of the components. The level of integration between the components may vary from one UE to another UE. Further, certain UEs may contain multiple instances of a component, such as multiple processors, memories, transceivers, transmitters, receivers, etc.

In FIG. 6, processing circuitry 601 may be configured to process computer instructions and data. Processing circuitry 601 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 601 may include two central processing units (CPUs). Data may be information in a form suitable for use by a computer.

In the depicted embodiment, input/output interface 605 may be configured to provide a communication interface to an input device, output device, or input and output device. UE 600 may be configured to use an output device via input/output interface 605. An output device may use the same type of interface port as an input device. For example, a USB port may be used to provide input to and output from UE 600. The output device may be a speaker, a sound card, a video card, a display, a monitor, a printer, an actuator, an emitter, a smartcard, another output device, or any combination thereof. UE 600 may be configured to use an input device via input/output interface 605 to allow a user to capture information into UE 600. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 6, RF interface 609 may be configured to provide a communication interface to RF components such as a transmitter, a receiver, and an antenna. Network connection interface 611 may be configured to provide a communication interface to network 643a. Network 643a may encompass wired and/or wireless networks such as a local-area network (LAN), a wide-area network (WAN), a computer network, a wireless network, a telecommunications network, another like network or any combination thereof. For example, network 643a may comprise a Wi-Fi network. Network connection interface 611 may be configured to include a receiver and a transmitter interface used to communicate with one or more other devices over a communication network according to one or more communication protocols, such as Ethernet, TCP/IP, SONET, ATM, or the like. Network connection interface 611 may implement receiver and transmitter functionality appropriate to the communication network links (e.g., optical, electrical, and the like). The transmitter and receiver functions may share circuit components, software or firmware, or alternatively may be implemented separately.

RAM 617 may be configured to interface via bus 602 to processing circuitry 601 to provide storage or caching of data or computer instructions during the execution of software programs such as the operating system, application programs, and device drivers. ROM 619 may be configured to provide computer instructions or data to processing circuitry 601. For example, ROM 619 may be configured to store invariant low-level system code or data for basic system functions such as basic input and output (I/O), startup, or reception of keystrokes from a keyboard that are stored in a non-volatile memory. Storage medium 621 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 621 may be configured to include operating system 623, application program 625 such as a web browser application, a widget or gadget engine or another application, and data file 627. Storage medium 621 may store, for use by UE 600, any of a variety of various operating systems or combinations of operating systems.

Storage medium 621 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 621 may allow UE 600 to access computer-executable instructions, application programs or the like, stored on transitory or non-transitory memory media, to off-load data, or to upload data. An article of manufacture, such as one utilizing a communication system may be tangibly embodied in storage medium 621, which may comprise a device readable medium.

In FIG. 6, processing circuitry 601 may be configured to communicate with network 643b using communication subsystem 631. Network 643a and network 643b may be the same network or networks or different network or networks. Communication subsystem 631 may be configured to include one or more transceivers used to communicate with network 643b. For example, communication subsystem 631 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 633 and/or receiver 635 to implement transmitter or receiver functionality, respectively, appropriate to the RAN links (e.g., frequency allocations and the like). Further, transmitter 633 and receiver 635 of each transceiver may share circuit components, software or firmware, or alternatively may be implemented separately.

In the illustrated embodiment, the communication functions of communication subsystem 631 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 631 may include cellular communication, Wi-Fi communication, Bluetooth communication, and GPS communication. Network 643b may encompass wired and/or wireless networks such as a local-area network (LAN), a wide-area network (WAN), a computer network, a wireless network, a telecommunications network, another like network or any combination thereof. For example, network 643b may be a cellular network, a Wi-Fi network, and/or a near-field network. Power source 613 may be configured to provide alternating current (AC) or direct current (DC) power to components of UE 600.

The features, benefits and/or functions described herein may be implemented in one of the components of UE 600 or partitioned across multiple components of UE 600. Further, the features, benefits, and/or functions described herein may be implemented in any combination of hardware, software or firmware. In one example, communication subsystem 631 may be configured to include any of the components described herein. Further, processing circuitry 601 may be configured to communicate with any of such components over bus 602. In another example, any of such components may be represented by program instructions stored in memory that when executed by processing circuitry 601 perform the corresponding functions described herein. In another example, the functionality of any of such components may be partitioned between processing circuitry 601 and communication subsystem 631. In another example, the non-computationally intensive functions of any of such components may be implemented in software or firmware and the computationally intensive functions may be implemented in hardware.

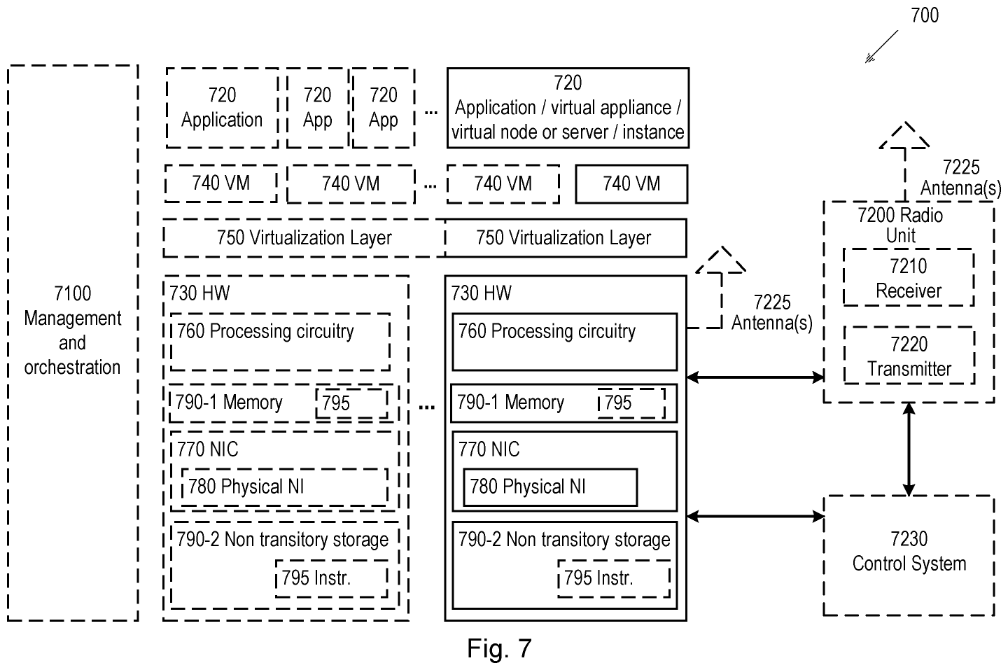

FIG. 7 is a schematic block diagram illustrating a virtualization environment 700 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 700 hosted by one or more of hardware nodes 730. Further, in embodiments in which the virtual node is not a radio access node or does not require radio connectivity (e.g., a core network node), then the network node may be entirely virtualized.

The functions may be implemented by one or more applications 720 (which may alternatively be called software instances, virtual appliances, network functions, virtual nodes, virtual network functions, etc.) operative to implement some of the features, functions, and/or benefits of some of the embodiments disclosed herein. Applications 720 are run in virtualization environment 700 which provides hardware 730 comprising processing circuitry 760 and memory 790. Memory 790 contains instructions 795 executable by processing circuitry 760 whereby application 720 is operative to provide one or more of the features, benefits, and/or functions disclosed herein.

Virtualization environment 700, comprises general-purpose or special-purpose network hardware devices 730 comprising a set of one or more processors or processing circuitry 760, which may be commercial off-the-shelf (COTS) processors, dedicated Application Specific Integrated Circuits (ASICs), or any other type of processing circuitry including digital or analog hardware components or special purpose processors. Each hardware device may comprise memory 790-1 which may be non-persistent memory for temporarily storing instructions 795 or software executed by processing circuitry 760. Each hardware device may comprise one or more network interface controllers (NICs) 770, also known as network interface cards, which include physical network interface 780. Each hardware device may also include non-transitory, persistent, machine-readable storage media 790-2 having stored therein software 795 and/or instructions executable by processing circuitry 760. Software 795 may include any type of software including software for instantiating one or more virtualization layers 750 (also referred to as hypervisors), software to execute virtual machines 740 as well as software allowing it to execute functions, features and/or benefits described in relation with some embodiments described herein.

Virtual machines 740, comprise virtual processing, virtual memory, virtual networking or interface and virtual storage, and may be run by a corresponding virtualization layer 750 or hypervisor. Different embodiments of the instance of virtual appliance 720 may be implemented on one or more of virtual machines 740, and the implementations may be made in different ways.

During operation, processing circuitry 760 executes software 795 to instantiate the hypervisor or virtualization layer 750, which may sometimes be referred to as a virtual machine monitor (VMM). Virtualization layer 750 may present a virtual operating platform that appears like networking hardware to virtual machine 740.

As shown in FIG. 7, hardware 730 may be a standalone network node with generic or specific components. Hardware 730 may comprise antenna 7225 and may implement some functions via virtualization. Alternatively, hardware 730 may be part of a larger cluster of hardware (e.g. such as in a data center or customer premise equipment (CPE)) where many hardware nodes work together and are managed via management and orchestration (MANO) 7100, which, among others, oversees lifecycle management of applications 720.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 740 may be a software implementation of a physical machine that runs programs as if they were executing on a physical, non-virtualized machine. Each of virtual machines 740, and that part of hardware 730 that executes that virtual machine, be it hardware dedicated to that virtual machine and/or hardware shared by that virtual machine with others of the virtual machines 740, forms a separate virtual network elements (VNE).

Still in the context of NFV, Virtual Network Function (VNF) is responsible for handling specific network functions that run in one or more virtual machines 740 on top of hardware networking infrastructure 730 and corresponds to application 720 in FIG. 7.

In some embodiments, one or more radio units 7200 that each include one or more transmitters 7220 and one or more receivers 7210 may be coupled to one or more antennas 7225. Radio units 7200 may communicate directly with hardware nodes 730 via one or more appropriate network interfaces and may be used in combination with the virtual components to provide a virtual node with radio capabilities, such as a radio access node or a base station.

In some embodiments, some signalling can be effected with the use of control system 7230 which may alternatively be used for communication between the hardware nodes 730 and radio units 7200.

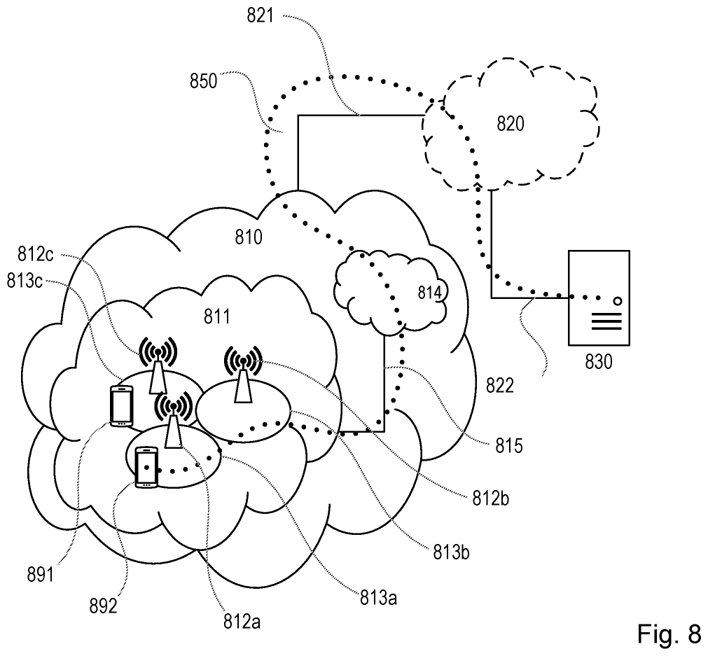

With reference to FIG. 8, in accordance with an embodiment, a communication system includes telecommunication network 810, such as a 3GPP-type cellular network, which comprises access network 811, such as a radio access network, and core network 814. Access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to core network 814 over a wired or wireless connection 815. A first UE 891 located in coverage area 813c is configured to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

Telecommunication network 810 is itself connected to host computer 830, which may be embodied in the hardware and/or software of a standalone server, a cloud-implemented server, a distributed server or as processing resources in a server farm. Host computer 830 may be under the ownership or control of a service provider, or may be operated by the service provider or on behalf of the service provider. Connections 821 and 822 between telecommunication network 810 and host computer 830 may extend directly from core network 814 to host computer 830 or may go via an optional intermediate network 820. Intermediate network 820 may be one of, or a combination of more than one of, a public, private or hosted network; intermediate network 820, if any, may be a backbone network or the Internet; in particular, intermediate network 820 may comprise two or more sub-networks (not shown).

The communication system of FIG. 8 as a whole enables connectivity between the connected UEs 891, 892 and host computer 830. The connectivity may be described as an over-the-top (OTT) connection 850. Host computer 830 and the connected UEs 891, 892 are configured to communicate data and/or signaling via OTT connection 850, using access network 811, core network 814, any intermediate network 820 and possible further infrastructure (not shown) as intermediaries. OTT connection 850 may be transparent in the sense that the participating communication devices through which OTT connection 850 passes are unaware of routing of uplink and downlink communications. For example, base station 812 may not or need not be informed about the past routing of an incoming downlink communication with data originating from host computer 830 to be forwarded (e.g., handed over) to a connected UE 891. Similarly, base station 812 need not be aware of the future routing of an outgoing uplink communication originating from the UE 891 towards the host computer 830.

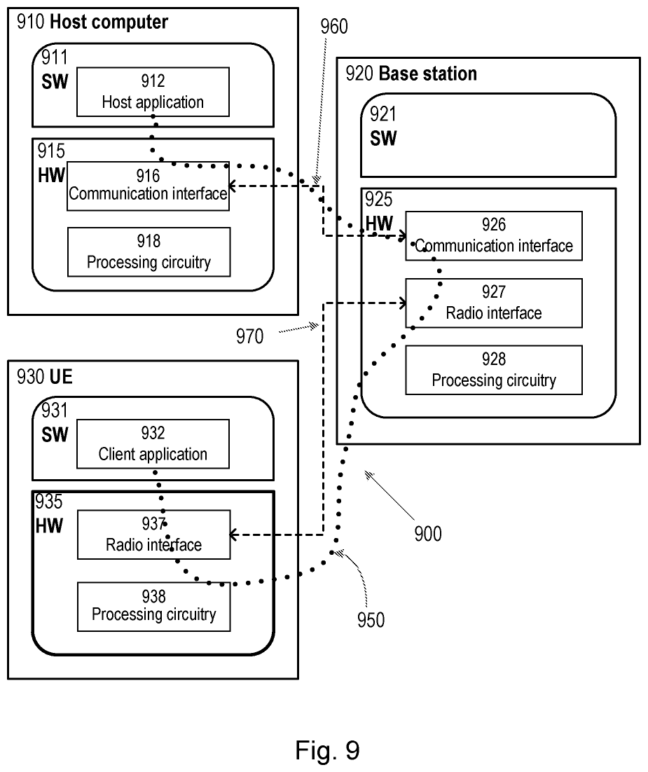

Example implementations, in accordance with an embodiment, of the UE, base station and host computer discussed in the preceding paragraphs will now be described with reference to FIG. 9. In communication system 900, host computer 910 comprises hardware 915 including communication interface 916 configured to set up and maintain a wired or wireless connection with an interface of a different communication device of communication system 900. Host computer 910 further comprises processing circuitry 918, which may have storage and/or processing capabilities. In particular, processing circuitry 918 may comprise one or more programmable processors, application-specific integrated circuits, field programmable gate arrays or combinations of these (not shown) adapted to execute instructions. Host computer 910 further comprises software 911, which is stored in or accessible by host computer 910 and executable by processing circuitry 918. Software 911 includes host application 912. Host application 912 may be operable to provide a service to a remote user, such as UE 930 connecting via OTT connection 950 terminating at UE 930 and host computer 910. In providing the service to the remote user, host application 912 may provide user data which is transmitted using OTT connection 950.

Communication system 900 further includes base station 920 provided in a telecommunication system and comprising hardware 925 enabling it to communicate with host computer 910 and with UE 930. Hardware 925 may include communication interface 926 for setting up and maintaining a wired or wireless connection with an interface of a different communication device of communication system 900, as well as radio interface 927 for setting up and maintaining at least wireless connection 970 with UE 930 located in a coverage area (not shown in FIG. 9) served by base station 920. Communication interface 926 may be configured to facilitate connection 960 to host computer 910. Connection 960 may be direct or it may pass through a core network (not shown in FIG. 9) of the telecommunication system and/or through one or more intermediate networks outside the telecommunication system. In the embodiment shown, hardware 925 of base station 920 further includes processing circuitry 928, which may comprise one or more programmable processors, application-specific integrated circuits, field programmable gate arrays or combinations of these (not shown) adapted to execute instructions. Base station 920 further has software 921 stored internally or accessible via an external connection.

Communication system 900 further includes UE 930 already referred to. Its hardware 935 may include radio interface 937 configured to set up and maintain wireless connection 970 with a base station serving a coverage area in which UE 930 is currently located. Hardware 935 of UE 930 further includes processing circuitry 938, which may comprise one or more programmable processors, application-specific integrated circuits, field programmable gate arrays or combinations of these (not shown) adapted to execute instructions. UE 930 further comprises software 931, which is stored in or accessible by UE 930 and executable by processing circuitry 938. Software 931 includes client application 932. Client application 932 may be operable to provide a service to a human or non-human user via UE 930, with the support of host computer 910. In host computer 910, an executing host application 912 may communicate with the executing client application 932 via OTT connection 950 terminating at UE 930 and host computer 910. In providing the service to the user, client application 932 may receive request data from host application 912 and provide user data in response to the request data. OTT connection 950 may transfer both the request data and the user data. Client application 932 may interact with the user to generate the user data that it provides.

It is noted that host computer 910, base station 920 and UE 930 illustrated in FIG. 9 may be similar or identical to host computer 830, one of base stations 812a, 812b, 812c and one of UEs 891, 892 of FIG. 8, respectively. This is to say, the inner workings of these entities may be as shown in FIG. 9 and independently, the surrounding network topology may be that of FIG. 8.

In FIG. 9, OTT connection 950 has been drawn abstractly to illustrate the communication between host computer 910 and UE 930 via base station 920, without explicit reference to any intermediary devices and the precise routing of messages via these devices. Network infrastructure may determine the routing, which it may be configured to hide from UE 930 or from the service provider operating host computer 910, or both. While OTT connection 950 is active, the network infrastructure may further take decisions by which it dynamically changes the routing (e.g., on the basis of load balancing consideration or reconfiguration of the network).

Wireless connection 970 between UE 930 and base station 920 is in accordance with the teachings of the embodiments described throughout this disclosure. One or more of the various embodiments improve the performance of OTT services provided to UE 930 using OTT connection 950, in which wireless connection 970 forms the last segment. More precisely, the teachings of these embodiments may reduce the length of service interruptions during handover and thereby provide benefits such as reduced user waiting time and better responsiveness.

A measurement procedure may be provided for the purpose of monitoring data rate, latency and other factors on which the one or more embodiments improve. There may further be an optional network functionality for reconfiguring OTT connection 950 between host computer 910 and UE 930, in response to variations in the measurement results. The measurement procedure and/or the network functionality for reconfiguring OTT connection 950 may be implemented in software 911 and hardware 915 of host computer 910 or in software 931 and hardware 935 of UE 930, or both. In embodiments, sensors (not shown) may be deployed in or in association with communication devices through which OTT connection 950 passes; the sensors may participate in the measurement procedure by supplying values of the monitored quantities exemplified above, or supplying values of other physical quantities from which software 911, 931 may compute or estimate the monitored quantities. The reconfiguring of OTT connection 950 may include message format, retransmission settings, preferred routing etc.; the reconfiguring need not affect base station 920, and it may be unknown or imperceptible to base station 920. Such procedures and functionalities may be known and practiced in the art. In certain embodiments, measurements may involve proprietary UE signaling facilitating host computer 910's measurements of throughput, propagation times, latency and the like. The measurements may be implemented in that software 911 and 931 causes messages to be transmitted, in particular empty or ‘dummy’ messages, using OTT connection 950 while it monitors propagation times, errors etc.

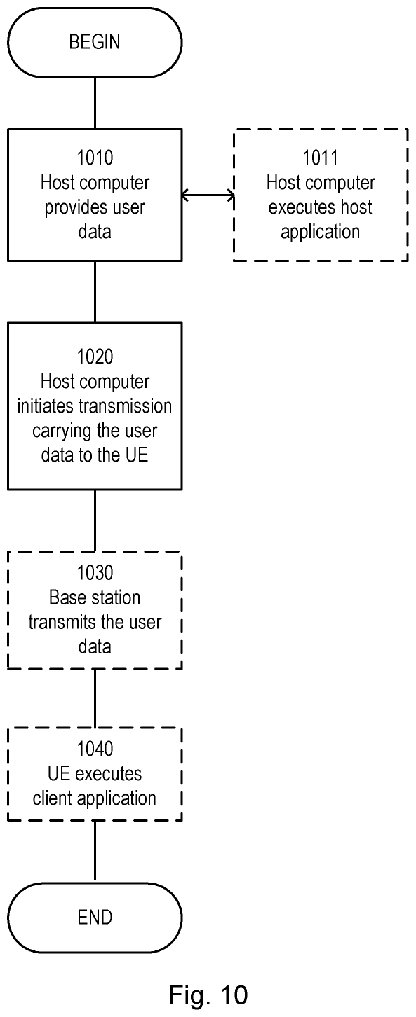

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

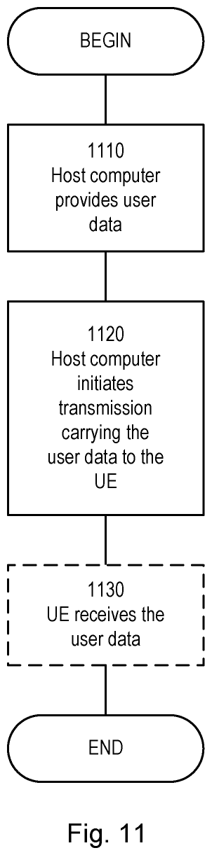

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

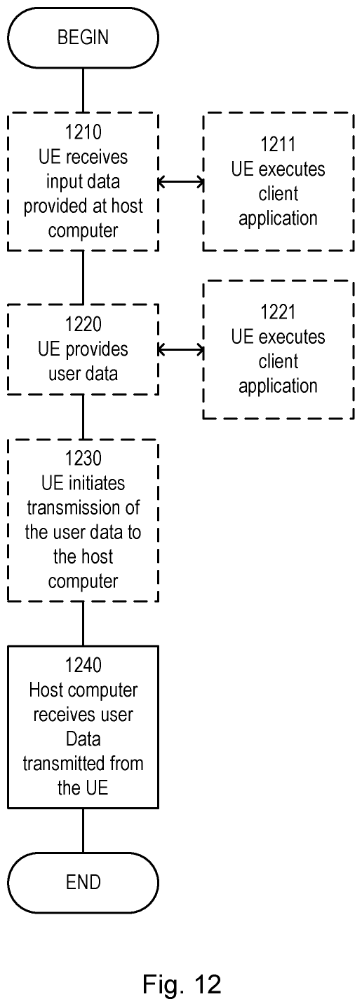

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

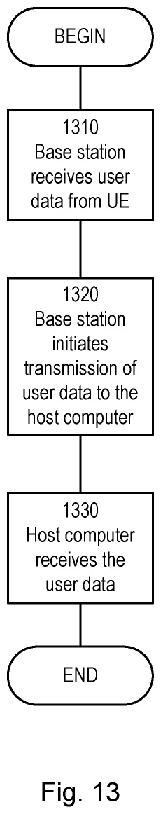

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

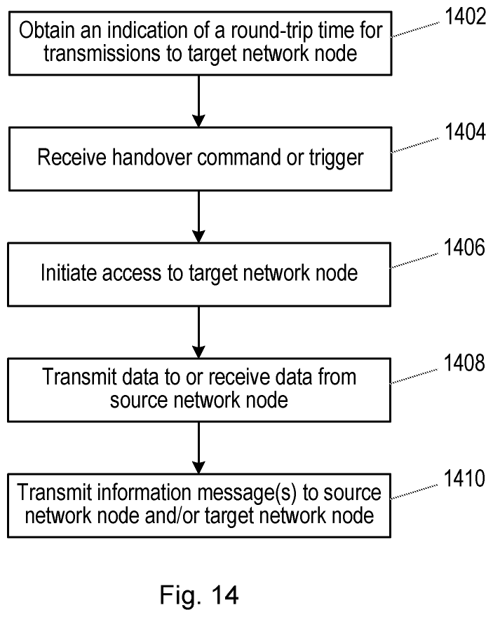

FIG. 14 depicts a method in accordance with particular embodiments. The method may be carried out by a wireless device or UE, such as the wireless device 510 or the UE 600 described above. In some respects the method corresponds to the signalling of the UE shown on the right-hand side of FIG. 4. The method may also correspond to the methods performed by the UE as described above (and with respect to FIG. 4).

Thus the method may relate to handover of the wireless device from a source network node to a target network node. The target network node may belong to a NTN. The source network node may or may not belong to the NTN.

The method begins at step 1402, in which the wireless device obtains an indication of a round-trip time for transmissions to the target network node. For example, the indication may be contained within a system information broadcast by the target network node, or in a message transmitted by the source network node (e.g., a handover message—see step 1404). The indication may comprise an indication of the round-trip time itself, for transmissions in the target network node, or a parameter which is related to the round-trip time. For example, such a parameter may comprise any propagation delay associated with transmissions to and/or from the target network node (e.g., a one way delay, a minimum delay, a differential delay, etc). The parameter may also comprise the duration of a time window following initiation of access to the target network node, in which the wireless device is permitted to transmit data to or receive data from the source network node (see step 1408 below).

In step 1404, the wireless device receives a handover command message or trigger from the source network node, instructing handover to the target network node. As noted above, in some embodiments the handover command message or trigger may contain the indication of the round-trip time referred to in step 1402. Those skilled in the art will appreciate that handover may be triggered by the network or requested by the wireless device itself, e.g., based on measurements of radio metrics of the source network node and the target network node. These aspects are not described in further detail herein.

In step 1406, the wireless device initiates access to the target network node, e.g., through the transmission of a random access message or preamble. The random access transmission opportunities may be indicated to the wireless device in the system information broadcast from the target network node, or in the handover command message, for example.

In step 1408, the wireless device continues to transmit and/or receive data from the source network node. Those skilled in the art will also appreciate that the transmissions may utilize radio resources which are scheduled or granted via transmissions on a downlink control channel such as the PDCCH, e.g., via DCI messages, and thus this step may comprise the wireless device monitoring the downlink control channel for any such scheduled or granted resources.

The data transmissions between the source network node and the UE may continue for a time window after access has been initiated to the target network node (e.g., a RA message has been transmitted). The time window may extend for approximately one RTT in the target network node (e.g., for non-contention-based random access in the target cell) or, as in the illustrated embodiment, approximately two RTTs in the target network node (e.g., for contention-based random access). After the time window has ended, the transmissions between the UE and the source network node may cease, with further data transmissions taking place between the UE and the target network node.

It will be noted that at certain times during the time window, no data transmissions take place between the UE and the source network node. These times may correspond to those times at which the UE is performing transmissions in the target cell, e.g., as part of the random access procedure. For example, the times may correspond to times at which the UE is monitoring for a random access response message (RAR or Msg2) from the target network node. Thus the time window may comprise one or more breaks in which data transmissions between the UE and the source network node do not take place.

In step 1410, the wireless device transmits information to the source network node and/or the target network node. Such information may be transmitted in one or more information messages, e.g., via an uplink control channel (such as the Physical Uplink Control Channel or similar).

For example, in one embodiment, the wireless device may transmit to the source network node an indication of when the random access preamble was sent in the target cell so that the source network node can make a more accurate estimation of the start and end of the RTT period (and/or the time window) in the target Cell. The UE may also transmit an indication of when Msg3 was sent in the target cell if four-step random access (e.g., contention based random access) is used in the target cell. This would avoid scheduling of the UE that will not be received.

Alternatively or additionally, the wireless device may transmit to the source network node an indication of when the wireless device will be active in the target cell, i.e., when the time window, in which data transmission in the source cell can take place, comes to an end.

Alternatively or additionally, the wireless device may transmit to the target network node a status report comprising an indication of which data packets have been successfully received from the source network node. The indication may comprise sequence numbers or ranges of sequence numbers. The packets can be indicated per bearer, per QoS flow, per PDU session, or in any other suitable granularity. This embodiment is particularly advantageous when the connection between the source network node and the wireless device is or is about to be terminated (e.g., upon establishment of a connection with the target network node), as the source network node may not be able to receive or transmit acknowledgement messages (e.g., ACK/NACK) in respect of data packets which are transmitted at such times.

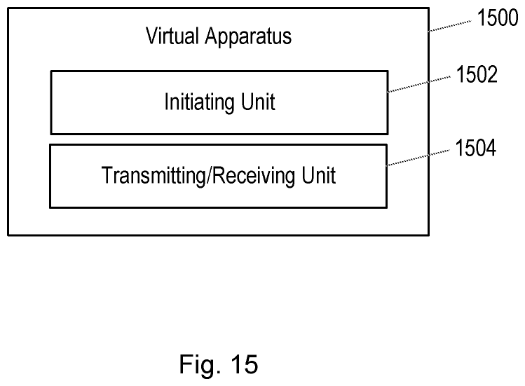

FIG. 15 illustrates a schematic block diagram of an apparatus 1500 in a wireless network (for example, the wireless network shown in FIG. 5). The apparatus may be implemented in a wireless device (e.g., wireless device 510 or UE 600). Apparatus 1500 is operable to carry out the example method described with reference to FIG. 14 and possibly any other processes or methods disclosed herein. It is also to be understood that the method of FIG. 14 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause initiating unit 1502 and transmitting/receiving unit 1504, and any other suitable units of apparatus 1500 to perform corresponding functions according one or more embodiments of the present disclosure.

The apparatus 1500 may be useful when implementing handover of the wireless device from a source network node to a target network node. As illustrated in FIG. 15, apparatus 1500 includes initiating unit 1502 and transmitting/receiving unit 1504. Initiating unit 1502 is configured to initiate access to the target network node (e.g., through transmission of a random access message to the target network node). Transmitting/receiving unit 1504 is configured to, subsequent to the initiation of access to the target network node, transmit data to or receive data from the source network node.

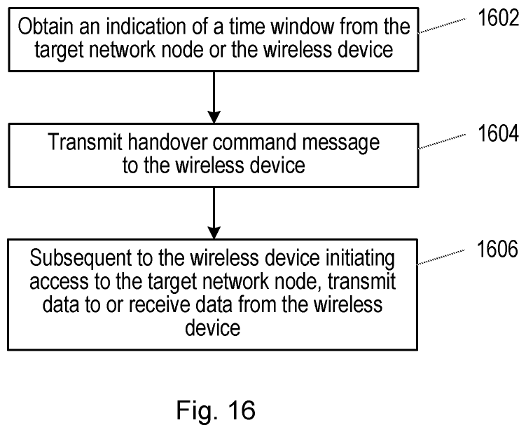

FIG. 16 depicts a method in accordance with particular embodiments. The method may be carried out by a network node or base station, such as the network node 560. In the particular context herein, the method may be carried out by a source network node in the handover of a wireless device from the source network node to a target network node. The target network node may belong to a non-terrestrial network. The source network node may also belong to the non-terrestrial network. In some respects the method corresponds to the signalling of the “Source Node” shown on the right-hand side of FIG. 4.

Thus the method may relate to handover of a wireless device from the source network node to a target network node. The target network node may belong to a NTN. The source network node may or may not belong to the NTN.

The method begins at step 1602, in which the source network node obtains an indication of a time window from the target network node or the wireless device. For example, the indication may be contained within a message transmitted by the target network node (e.g., via a direct interface such as the Xn interface). The indication may comprise an indication of the time window, the round-trip time for transmissions to and/or from the target network node, or a parameter which is related to the round-trip time. For example, such a parameter may comprise any propagation delay associated with transmissions to and/or from the target network node (e.g., a one way delay, a minimum delay, a differential delay, etc).

In step 1604, the source network node transmits a handover command message or trigger to the wireless device instructing handover to the target network node. In some embodiments the handover command message or trigger may contain the indication of the round-trip time or time window referred to in step 1602. Those skilled in the art will appreciate that handover may be triggered by the network or requested by the wireless device itself, e.g., based on measurements of radio metrics of the source network node and the target network node. These aspects are not described in further detail herein.

In step 1606, subsequent to the wireless device initiating access to the target network node, the source network node transmits data to or receives data from the wireless device.

The data transmissions between the source network node and the UE may continue for a time window after access has been initiated to the target network node (e.g., a RA message has been transmitted). The time window may extend for approximately one RTT in the target network node (e.g., for non-contention-based random access in the target cell) or, as in the illustrated embodiment, approximately two RTTs in the target network node (e.g., for contention-based random access). After the time window has ended, the transmissions between the UE and the source network node may cease, with further data transmissions taking place between the UE and the target network node.

It will be noted that at certain times during the time window, no data transmissions take place between the UE and the source network node. These times may correspond to those times at which the UE is performing transmissions in the target cell, e.g., as part of the random access procedure. For example, the times may correspond to times at which the UE is monitoring for a random access response message (RAR or Msg2) from the target network node. Thus the time window may comprise one or more breaks in which data transmissions between the UE and the source network node do not take place.

In one embodiment, the wireless device may transmit to the source network node an indication of when the random access preamble was sent in the target cell so that the source network node can make a more accurate estimation of the start and end of the RTT period (and/or the time window) in the target Cell. The UE may also transmit an indication of when Msg3 was sent in the target cell if four-step random access (e.g., contention based random access) is used in the target cell. Thus the source network node obtains an indication as to the times at which the wireless device is likely to be unreachable owing to its interactions with the target network node (e.g., listening for responses from the target network node). Alternatively or additionally, the wireless device may transmit to the source network node an indication of when the wireless device will be active in the target cell, i.e., when the time window, in which data transmission in the source cell can take place, comes to an end. The source network node may thus avoid scheduling of the UE during these breaks in the time window.

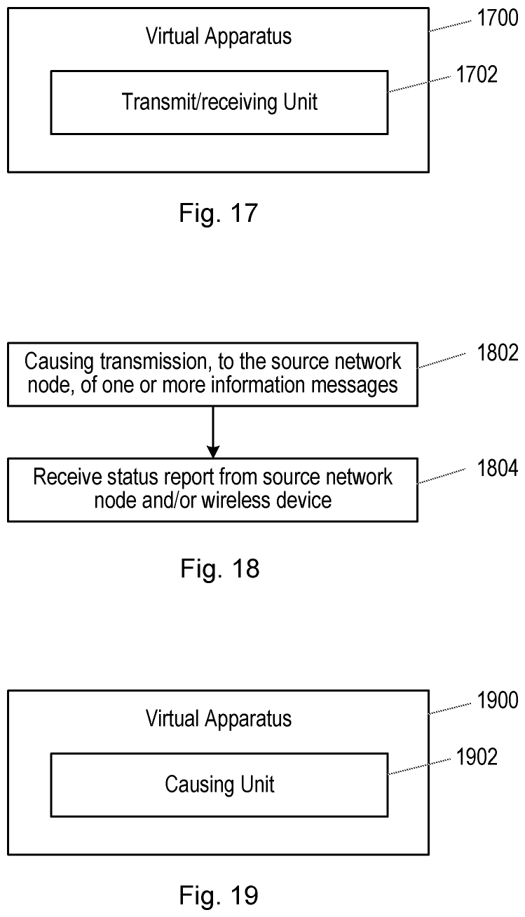

FIG. 17 illustrates a schematic block diagram of an apparatus 1700 in a wireless network (for example, the wireless network shown in FIG. 5). The apparatus may be implemented in a network node or base station (e.g., network node 560). Apparatus 1700 is operable to carry out the example method described with reference to FIG. 16 and possibly any other processes or methods disclosed herein. It is also to be understood that the method of FIG. 16 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause causing unit 1702, and any other suitable units of apparatus 1700 to perform corresponding functions according one or more embodiments of the present disclosure.

The apparatus 1700 may be useful when implementing handover of a wireless device from the source network node to a target network node. As illustrated in FIG. 17, apparatus 1700 includes transmitting/receiving unit 1702. Transmitting/receiving unit 1702 is configured to, subsequent to the wireless device initiating access to the target network node, transmit data to or receive data from the wireless device.

FIG. 18 depicts a method in accordance with particular embodiments. The method may be carried out by a network node or base station, such as the network node 560. In the particular context herein, the method may be carried out by a target network node in the handover of a wireless device from a source network node to the target network node. The target network node may belong to a non-terrestrial network. The source network node may also belong to the non-terrestrial network. In some respects the method may be combined with the signalling of the “Target Node” shown on the right-hand side of FIG. 4.

Thus the method may relate to handover of a wireless device from a source network node to the target network node. The target network node may belong to a NTN. The source network node may or may not belong to the NTN. The method shown in FIG. 18 may be particularly applicable in a target network node which is ground-based, but which transmits to or receives transmissions from the wireless device via an airborne or spaceborne vehicle as described above.

The method begins at step 1802, in which the target network node causes transmission, to the source network node, of information relating to the handover of the wireless device to the target network node. Thus, in one embodiment, step 1802 is performed subsequent to initiation of the handover of the wireless device from the source network node to the target network node. For example, in one embodiment the indication may be transmitted subsequent to receipt of a random access message from the wireless device by the target network node. The information may be transmitted via a direct interface between the target network node and the source network node (e.g., Xn).

For example, the information may comprise an indication of a time window following initiation of access to the target network node by the wireless device, in which the source network node is able to transmit data to or receive data from the wireless device.

The time window may extend for approximately one RTT in the target network node (e.g., for non-contention-based random access in the target cell) or, as in the embodiment illustrated in FIG. 4, approximately two RTTs in the target network node (e.g., for contention-based random access). After the time window has ended, the transmissions between the UE and the source network node may cease, with further data transmissions taking place between the UE and the target network node.

It will be noted that at certain times during the time window, no data transmissions take place between the UE and the source network node. These times may correspond to those times at which the UE is performing transmissions in the target cell, e.g., as part of the random access procedure. For example, the times may correspond to times at which the UE is monitoring for a random access response message (RAR or Msg2) from the target network node. Thus the time window may comprise one or more breaks in which data transmissions between the UE and the source network node do not take place.

In one embodiment, the target network node may transmit to the source network node an indication of when the random access preamble was received in the target cell or the RAR message was sent, so that the source network node can make a more accurate estimation of the start and end of the RTT period (and/or the time window) in the target Cell. The target network node may also transmit an indication of when Msg3 was received in the target cell or the Msg4 was sent, if four-step random access (e.g., contention based random access) is used in the target cell. In this way, the source network node obtains an indication as to the times at which the wireless device is likely to be unreachable owing to its interactions with the target network node (e.g., listening for responses from the target network node).

In step 1804, the target network node receives a status report from the wireless device or the source network node comprising an indication of which data packets have been successfully received by the wireless device from the source network node. The indication may comprise sequence numbers or ranges of sequence numbers. The packets can be indicated per bearer, per QoS flow, per PDU session, or in any other suitable granularity. Receiving the status report from the wireless device may be particularly advantageous when the connection between the source network node and the wireless device is or is about to be terminated (e.g., upon establishment of a connection with the target network node), as the source network node may not be able to receive or transmit acknowledgement messages (e.g., ACK/NACK) in respect of data packets which are transmitted at such times.

FIG. 19 illustrates a schematic block diagram of an apparatus 1900 in a wireless network (for example, the wireless network shown in FIG. 5). The apparatus may be implemented in a network node or base station (e.g., network node 560). Apparatus 1900 is operable to carry out the example method described with reference to FIG. 18 and possibly any other processes or methods disclosed herein. It is also to be understood that the method of FIG. 18 is not necessarily carried out solely by apparatus 1900. At least some operations of the method can be performed by one or more other entities.

Virtual Apparatus 1900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause causing unit 1902, and any other suitable units of apparatus 1900 to perform corresponding functions according one or more embodiments of the present disclosure.

The apparatus 1900 may be useful when implementing handover of a wireless device from a source network node to the target network node. As illustrated in FIG. 19, apparatus 1900 includes causing unit 1902. Causing unit 1902 is configured to cause transmission, to the source network node, of an indication of a time window following initiation of access to the target network node by the wireless device, in which the source network node is to transmit data to or receive data from the wireless device.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The following numbered paragraphs set out some embodiments of the disclosure.

### Group A Embodiments

1. A method performed by a wireless device for performing handover from a source network node to a target network node, the method comprising:
   initiating access to the target network node; and
   subsequent to initiating access to the target network node, transmitting data to or receiving data from the source network node.
2. The method of embodiment 1, wherein the wireless device transmits data to or receives data from the source network node for a time window following initiation of access to the target network node.
3. The method of embodiment 2, wherein the time window has a duration of at least a round-trip time for transmissions to the target network node.
4. The method of embodiment 3, wherein the time window has a duration of at least two round-trip times for transmission to the target network node.
5. The method of embodiment 4, in which access to the target network node is through contention-based random access.
6. The method of any one of embodiments 3 to 5, further comprising obtaining an indication of the round-trip time for transmissions to the target network node.
7. The method of embodiment 6, wherein the indication of the round-trip time comprises an indication of a propagation delay for transmissions to or from the target network node.
8. The method of embodiment 6 or 7, wherein obtaining the indication of the round-trip time comprises one or more of:
   receiving the indication of the round-trip time in a system information broadcast from the target network node; and
   receiving the indication of the round-trip time in a handover command or trigger from the source network node.
9. The method of any one of embodiments 2 to 8, wherein the wireless device transmits data to or receives data from the source network node for the time window, with the exception of one or more breaks in the time window in which the wireless device monitors for a response message from the target network node.
10. The method of embodiment 9, further comprising transmitting, to the source network node, an indication of the one or more breaks in the time window.
11. The method of any preceding embodiment, wherein transmitting data to or receiving data from the source network node comprises monitoring a downlink control channel configured for the source network node.
12. The method of embodiment 11, wherein monitoring a downlink control channel configured for the source network node comprises monitoring the downlink control channel for a grant of uplink resources or an indication of downlink resources on which a transmission is to take place.
13. The method of any preceding embodiment, wherein initiating access to the target network node comprises transmitting a random access message to the target network node.
14. The method of any preceding embodiment, further comprising transmitting a first information message to the source network node, comprising an indication of a time at which access to the target network node was initiated.
15. The method of any preceding embodiment, further comprising transmitting a second information message to the source network node, comprising an indication of a time at which a Message 3 of a random access process was transmitted to the target network node.
16. The method of any preceding embodiment, further comprising transmitting a status report to the target network node comprising an indication of data packets which were successfully received from the source network node.
17. The method of any preceding embodiment, wherein at least the target network node belongs to a non-terrestrial network.
18. The method of embodiment 17, wherein transmissions to or from the target network node are directed via an airborne or spaceborne vehicle.
19. The method of embodiment 18, wherein the target network node is implemented in the airborne or spaceborne vehicle.
20. The method of embodiment 18, wherein the target network node is ground-based, and wherein the airborne or spaceborne vehicle comprises a mechanism for forwarding transmissions between the wireless device and the target network node.
21. The method of any of the previous embodiments, further comprising:
   providing user data; and
   forwarding the user data to a host computer via the transmission to the source network node.

### Group B Embodiments

22. A method performed by a source network node during handover of a wireless device from the source network node to a target network node, the method comprising:
   subsequent to the wireless device initiating access to the target network node, transmitting data to or receiving data from the wireless device.
23. The method of embodiment 22, wherein the source network node transmits data to or receives data from the wireless device for a time window following the initiation of access to the target network node.
24. The method of embodiment 23, further comprising receiving an indication of the time window from the target network node.
25. The method of embodiment 23 or 24, wherein the time window has a duration of at least a round-trip time for transmissions from the wireless device to the target network node.
26. The method of embodiment 25, wherein the time window has a duration of at least two round-trip times for transmission from the wireless device to the target network node.
27. The method of embodiment 26, in which access to the target network node is through contention-based random access.
28. The method of any one of embodiments 25 to 27, further comprising obtaining an indication of the round-trip time for transmissions from the wireless device to the target network node.
29. The method of embodiment 28, wherein the indication of the round-trip time comprises an indication of a propagation delay for transmissions to or from the target network node.
30. The method of embodiment 28 or 29, wherein obtaining the indication of the round-trip time comprises receiving the indication of the round-trip time from the target network node.
31. The method of any one of embodiments 23 to 30, wherein the source network node transmits data to or receives data from the wireless device for the time window, with the exception of one or more breaks in the time window in which the wireless device monitors for a response message from the target network node.
32. The method of embodiment 31, further comprising receiving a control message from the wireless device or the target network node comprising an indication of the one or more breaks in the time window.
33. The method of any of embodiments 22 to 32, wherein transmitting data to or receiving data from the source network node comprises transmitting, via a downlink control channel, a grant of uplink resources or an indication of downlink resources on which a transmission is to take place.
34. The method of any of embodiments 22 to 33, wherein initiating access to the target network node comprises transmitting a random access message to the target network node.
35. The method of any of embodiments 22 to 34, further comprising receiving a first information message from the wireless device or the target network node, comprising an indication of a time at which access to the target network node was initiated.
36. The method of embodiment 35 as dependent on any of embodiments 23 to 32, further comprising determining a duration of the time window in dependence on the time at which access to the target network node was initiated.
37. The method of any of embodiments 22 to 36, further comprising receiving a second information message from the wireless device or the target network node, comprising an indication of a time at which a Message 3 of a random access process was transmitted to the target network node or received by the target network node.
38. The method of any of embodiments 22 to 37, wherein at least the target network node belongs to a non-terrestrial network.
39. The method of embodiment 38, wherein transmissions to or from the target network node are directed via an airborne or spaceborne vehicle.
40. The method of embodiment 39, wherein the target network node is implemented in the airborne or spaceborne vehicle.
41. The method of embodiment 39, wherein the target network node is ground-based, and wherein the airborne or spaceborne vehicle comprises a mechanism for forwarding transmissions between the wireless device and the target network node.
42. The method of any one of embodiments 22 to 41, further comprising, prior to transmitting data to or receiving data from the wireless device, transmitting a handover command or trigger to the wireless device.
43. A method performed by a target network node relating to handover of a wireless device from a source network node to the target network node, the method comprising:
   causing transmission, to the source network node, of an indication of a time window following initiation of access to the target network node by the wireless device, in which the source network node is to transmit data to or receive data from the wireless device.
44. The method of embodiment 43, wherein the time window has a duration of at least a round-trip time for transmissions from the wireless device to the target network node.
45. The method of embodiment 44, wherein the time window has a duration of at least two round-trip times for transmission from the wireless device to the target network node.
46. The method of embodiment 45, in which access to the target network node is through contention-based random access.
47. The method of any one of embodiments 44 to 46, further comprising transmitting an indication of the round-trip time to the source network node.
48. The method of embodiment 47, wherein the indication of the round-trip time comprises an indication of a propagation delay for transmissions to or from the target network node.
49. The method of any one of embodiments 43 to 48, wherein the indication of the time window further comprises an indication of one or more breaks in the time window in which the wireless device monitors for a response message from the target network node.
50. The method of any of embodiments 43 to 49, wherein the indication of the time window is transmitted to the source network node responsive to the wireless device initiating access to the target network node.
51. The method of embodiment 50, wherein the wireless device initiating access to the target network node comprises receiving a random access message from the wireless device.
52. The method of any of embodiments 43 to 51, further comprising transmitting, to the source network node, an indication of a time at which access to the target network node was initiated by the wireless device.
53. The method of any of embodiments 43 to 52, further comprising transmitting, to the source network node, an indication of a time at which a Message 3 of a random access process was transmitted to the target network node or received by the target network node.
54. The method of any of embodiments 43 to 53, further comprising receiving a status report from the wireless device comprising an indication of data packets which were successfully received from the source network node.
55. The method of any of embodiments 43 to 54, wherein at least the target network node belongs to a non-terrestrial network.
56. The method of embodiment 55, wherein transmissions to or from the target network node are directed via an airborne or spaceborne vehicle.
57. The method of embodiment 56, wherein the target network node is implemented in the airborne or spaceborne vehicle.
58. The method of embodiment 56, wherein the target network node is ground-based, and wherein the airborne or spaceborne vehicle comprises a mechanism for forwarding transmissions between the wireless device and the target network node.
59. The method of any of embodiments 22 to 58, further comprising:
   obtaining user data; and
   forwarding the user data to a host computer or a wireless device.

### Group C Embodiments

60. A wireless device, the wireless device comprising:
   processing circuitry configured to perform any of the steps of any of the Group A embodiments; and
   power supply circuitry configured to supply power to the wireless device.
61. A base station, the base station comprising:
   processing circuitry configured to perform any of the steps of any of the Group B embodiments;
   power supply circuitry configured to supply power to the base station.
62. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
63. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
64. The communication system of the previous embodiment further including the base station.
65. The communication system of the previous 2 embodiments, further including the UE, wherein the UE is configured to communicate with the base station.
66. The communication system of the previous 3 embodiments, wherein:
   the processing circuitry of the host computer is configured to execute a host application, thereby providing the user data; and
   the UE comprises processing circuitry configured to execute a client application associated with the host application.
67. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
68. The method of the previous embodiment, further comprising, at the base station, transmitting the user data.
69. The method of the previous 2 embodiments, wherein the user data is provided at the host computer by executing a host application, the method further comprising, at the UE, executing a client application associated with the host application.
70. A user equipment (UE) configured to communicate with a base station, the UE comprising a radio interface and processing circuitry configured to performs the of the previous 3 embodiments.
71. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
72. The communication system of the previous embodiment, wherein the cellular network further includes a base station configured to communicate with the UE.
73. The communication system of the previous 2 embodiments, wherein:
   the processing circuitry of the host computer is configured to execute a host application, thereby providing the user data; and
   the UE's processing circuitry is configured to execute a client application associated with the host application.
74. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
75. The method of the previous embodiment, further comprising at the UE, receiving the user data from the base station.
76. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
77. The communication system of the previous embodiment, further including the UE.
78. The communication system of the previous 2 embodiments, further including the base station, wherein the base station comprises a radio interface configured to communicate with the UE and a communication interface configured to forward to the host computer the user data carried by a transmission from the UE to the base station.
79. The communication system of the previous 3 embodiments, wherein:
   the processing circuitry of the host computer is configured to execute a host application; and
   the UE's processing circuitry is configured to execute a client application associated with the host application, thereby providing the user data.
80. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
81. A method implemented in a communication system including a host computer, a base station and a user equipment (UE), the method comprising:
   at the host computer, receiving user data transmitted to the base station from the UE, wherein the UE performs any of the steps of any of the Group A embodiments.
82. The method of the previous embodiment, further comprising, at the UE, providing the user data to the base station.
83. The method of the previous 2 embodiments, further comprising:
   at the UE, executing a client application, thereby providing the user data to be transmitted; and
   at the host computer, executing a host application associated with the client application.
84. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
85. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
86. The communication system of the previous embodiment further including the base station.
87. The communication system of the previous 2 embodiments, further including the UE, wherein the UE is configured to communicate with the base station.
88. The communication system of the previous 3 embodiments, wherein:
   the processing circuitry of the host computer is configured to execute a host application;
   the UE is configured to execute a client application associated with the host application, thereby providing the user data to be received by the host computer.
89. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
90. The method of the previous embodiment, further comprising at the base station, receiving the user data from the UE.
91. The method of the previous 2 embodiments, further comprising at the base station, initiating a transmission of the received user data to the host computer.

1.-34. (canceled)

35. A method performed by a wireless device for performing handover from a source network node to a target network node, the method comprising:
obtaining an indication of a round-trip time for transmissions to the target network node;
initiating access to the target network node; and
subsequent to initiating access to the target network node, transmitting data to or receiving data from the source network node for a time window following initiation of access to the target network node, wherein the time window has a duration of at least the round-trip time for transmissions to the target network node.

36. The method of claim 35, wherein the time window has a duration of at least two round-trip times for transmission to the target network node.

37. The method of claim 35, wherein the indication of the round-trip time comprises an indication of a propagation delay for transmissions to or from the target network node.

38. The method of claim 35, wherein obtaining the indication of the round-trip time comprises one or more of:
receiving the indication of the round-trip time in a system information broadcast from the target network node; and
receiving the indication of the round-trip time in a handover command or trigger from the source network node.

39. The method of claim 35, further comprising transmitting a first information message to the source network node, the first information message comprising an indication of a time at which access to the target network node was initiated.

40. The method of claim 35, further comprising transmitting a second information message to the source network node, the second information message comprising an indication of a time at which a Message 3 of a random access process was transmitted to the target network node.

41. A wireless device, the wireless device comprising:
power supply circuitry configured to supply power to the wireless device; and
processing circuitry configured to, when performing handover of the wireless device from a source network node to a target network node:
obtain an indication of a round-trip time for transmissions to the target network node;
initiate access to the target network node; and
subsequent to initiating access to the target network node, transmit data to or receive data from the source network node for a time window following initiation of access to the target network node, wherein the time window has a duration of at least the round-trip time for transmissions to the target network node.

42. The wireless device of claim 41, wherein the time window has a duration of at least two round-trip times for transmission to the target network node.

43. The wireless device of claim 41, wherein the indication of the round-trip time comprises an indication of a propagation delay for transmissions to or from the target network node.

44. The wireless device of claim 41, wherein the processing circuitry is further configured to obtain the indication of the round-trip time by one or more of:
receiving the indication of the round-trip time in a system information broadcast from the target network node; and
receiving the indication of the round-trip time in a handover command or trigger from the source network node.

45. The wireless device of claim 41, wherein the processing circuitry is further configured to cause transmission of a first information message to the source network node, the first information message comprising an indication of a time at which access to the target network node was initiated.

46. The wireless device of claim 41, wherein the processing circuitry is further configured to cause transmission of a second information message to the source network node, the second information message comprising an indication of a time at which a Message 3 of a random access process was transmitted to the target network node.

47. A network node, the network node comprising:
processing circuitry configured to, when performing handover of a wireless device from the network node, acting as a source network node, to a target network node:
obtain an indication of a round-trip time for transmissions from the wireless device to the target network node; and
subsequent to the wireless device initiating access to the target network node, transmit data to or receive data from the wireless device for a time window following the initiation of access to the target network node, wherein the time window has a duration of at least the round-trip time for transmissions from the wireless device to the target network node.

48. The network node of claim 47, wherein the time window has a duration of at least two round-trip times for transmission from the wireless device to the target network node.

49. The network node of claim 47, wherein the processing circuitry is further configured to obtain the indication of the round-trip time by receiving the indication of the round-trip time from the target network node.

50. The network node of claim 47, wherein the processing circuitry is further configured to receive a first information message from the wireless device or the target network node, the first information message comprising an indication of a time at which access to the target network node was initiated.

51. The network node of claim 47, wherein the processing circuitry is configured to receive a second information message from the wireless device or the target network node, the second information message comprising an indication of a time at which a Message 3 of a random access process was transmitted to the target network node or received by the target network node.

52. A network node, the network node comprising:
power supply circuitry configured to supply power to the network node; and
processing circuitry configured to, when performing handover of a wireless device to the network node, acting as a target network node, from a source network node:
cause transmission, to the source network node, of an indication of a time window following initiation of access to the network node by the wireless device, in which the source network node is to transmit data to or receive data from the wireless device.

53. The network node of claim 52, wherein the time window has a duration of at least a round-trip time for transmissions from the wireless device to the network node.

54. The network node of claim 52, wherein the time window has a duration of at least two round-trip times for transmission from the wireless device to the network node.
